(19) United States
(12) Patent Application Publication
(10) Pub. No.: US 2026/0131362 A1
(43) Pub. Date: May 14, 2026

(54) ELECTRIC NEEDLE SCALER

(71) Applicant: Makita Corporation, Anjo-shi (JP)

(72) Inventors: Tomohiro SAEKI, Anjo-shi (JP); Masanori Furusawa, Anjo-shi (JP); Kei Watanabe, Anjo-shi (JP); Yuji Sakakibara, Anjo-shi (JP)

(73) Assignee: Makita Corporation, Anjo-shi (JP)

(21) Appl. No.: 19/379,150

(22) Filed: Nov. 4, 2025

(30) Foreign Application Priority Data
Nov. 11, 2024 (JP) 2024-196581
Nov. 25, 2024 (JP) 2024-204740
Sep. 22, 2025 (JP) 2025-157501

(51) Int. Cl. B08B 7/02; B25D 9/14; B25D 17/02

(52) U.S. Cl. CPC B08B 7/022; B25D 9/14; B25D 17/02; B25D 2250/291

(57) ABSTRACT

A needle scaler includes: a tool body, at least part of which extends along a driving axis that defines a front-rear direction of the needle scaler; an electric motor that is housed in the tool body; a battery mounting part that is configured to removably receive a battery; a power transmitting mechanism that is housed in the tool body; and a scaling mechanism that is supported by a front end part of the tool body. The scaling mechanism includes needles. The needles protrude forward to be exposed out of the tool body and are supported to be movable in respective axial directions of the needles. The power transmitting mechanism includes a power transmitting part. The power transmitting part is operably connected to the output shaft of the motor and reciprocates along the driving axis by utilizing rotation of the output shaft and transmit axial force to the needles.

### CROSS-REFERENCE TO RELATED APPLICATIONS

The present application claims priority to Japanese Patent Application No. 2024-196581, filed on November 11, 2024; Japanese Patent Application No. 2024-204740, filed on November 25, 2024; and Japanese Patent Application No. 2025-157501, filed on September 22, 2025. The contents of the foregoing applications are hereby fully incorporated herein by reference.

### TECHNICAL FIELD

The present disclosure relates to an electric needle scaler.

### BACKGROUND

A needle scaler (also referred to as a needle gun scaler or a needle gun) is a tool for removing foreign matters from a surface of a workpiece. The needle scaler has a number of needles (also referred to as pins) that are each axially movably supported by a support. The needle scaler is configured to remove foreign matters from a surface of a workpiece by applying hammering force to the needles and hitting the workpiece with tips of the needles. For example, a needle scaler disclosed in Japanese Utility Model Application Publication No. S63-34865 is configured to strike an anvil with a hammer that is reciprocated by an electric motor so as to apply hammering force to the needles via the anvil.

### SUMMARY

The needle scaler is desired to be further improved in durability and convenience.

It is accordingly a non-limiting object of the present disclosure to provide a technique that contributes to improvement of the durability and convenience of an electric needle scaler.

According to one non-limiting aspect of the present disclosure, an electric needle scaler is provided that has a tool body, a motor, a battery mounting part, a power transmitting mechanism and a scaling mechanism.

At least part of the tool body extends along a driving axis that defines a front-rear direction of the needle scaler. The motor is an electric motor and is housed in the tool body. The motor includes an output shaft that is rotatable around a first rotational axis. The battery mounting part is configured to removably receive a battery. The power transmitting mechanism is housed in the tool body. The scaling mechanism includes needles. The needles protrude forward to be exposed out of the tool body and are supported to be movable in respective axial directions of the needles. The power transmitting mechanism includes a power transmitting part. The power transmitting part is operably connected to the output shaft of the motor and reciprocates along the driving axis by utilizing rotation of the output shaft and transmit force to the needles in the respective axial directions.

The needle scaler according to this aspect has the battery mounting part to which a battery can be mounted. Therefore, the needle scaler is provided with excellent operability and portability and thus with excellent convenience, compared with a needle scaler that can be connected to an external commercial power source.

According to another non-limiting aspect of the present disclosure, an electric needle scaler is provided that has a tool body, a motor, a hammering mechanism and a scaling mechanism.

The tool body extends along a driving axis that defines a front-rear direction of the needle scaler. The motor is an electric motor and is housed in the tool body. The motor includes an output shaft that is rotatable around a first rotational axis. The hammering mechanism is housed in the tool body. The scaling mechanism is supported by a front end part of the tool body and includes needles. The needles protrude forward to be exposed out of the tool body and are supported to be movable in respective axial directions of the needles. The hammering mechanism includes a piston and a striker. The piston is operably connected to the output shaft of the motor and configured to reciprocate along the driving axis along with rotation of the output shaft. The striker is configured to reciprocate along the driving axis by pressure fluctuations caused in an air chamber by reciprocation of the piston and apply hammering force to the needles.

The needle scaler according to this aspect has the hammering mechanism that is driven by power of the electric motor. The hammering mechanism reciprocates the striker by the action of air spring, or specifically by pressure fluctuations caused in the air chamber by reciprocation of the piston, and applies hammering force to the needles of the scaling mechanism. Therefore, the needle scaler is provided with excellent durability, compared with a structure in which the piston and the striker are connected by a mechanical spring (such as a compression coil spring) in order to apply the hammering force.

### BRIEF DESCRIPTION OF THE DRAWINGS

FIG. 1 is a left side view of a needle scaler according to a first embodiment.

FIG. 2 is a front perspective view of the needle scaler.

FIG. 3 is a sectional view of the needle scaler.

FIG. 4 is a sectional view taken along line IV-IV in FIG. 1.

FIG. 5 is a partial, enlarged view of FIG. 3.

FIG. 6 is a sectional view taken along line VI-VI in FIG. 4.

FIG. 7 is a left side view of a needle scaler according to a second embodiment.

FIG. 8 is a sectional view of the needle scaler.

FIG. 9 is a rear perspective view of the needle scaler with a battery removed therefrom.

FIG. 10 is a sectional view taken along line X-X in FIG. 8.

FIG. 11 is an explanatory view for showing a using manner of the needle scaler.

FIG. 12 is an explanatory view showing a needle scaler according to a third embodiment.

FIG. 13 is an explanatory view showing a needle scaler according to a fourth embodiment.

FIG. 14 is an explanatory view showing a needle scaler according to a fifth embodiment.

FIG. 15 is an explanatory view showing a needle scaler according to a sixth embodiment.

FIG. 16 is an explanatory view showing a needle scaler according to a seventh embodiment.

FIG. 17 is an explanatory view showing a needle scaler according to an eighth embodiment.

FIG. 18 is an explanatory view showing a needle scaler according to a ninth embodiment.

FIG. 19 is an explanatory view showing a needle scaler according to a tenth embodiment.

FIG. 20 is an explanatory view showing a needle scaler according to an eleventh embodiment.

FIG. 21 is an explanatory view showing a needle scaler according to a twelfth embodiment.

FIG. 22 is an explanatory view showing a needle scaler according to a thirteenth embodiment.

### DETAILED DESCRIPTION OF THE EMBODIMENTS

In one non-limiting embodiment according to the present disclosure, the power transmitting mechanism may include a reciprocating member and a striker as the power transmitting part. The reciprocating member is operably connected to the output shaft of the motor and reciprocates along the driving axis along with rotation of the output shaft. The striker applies hammering force to the needles by reciprocation of the reciprocating member.

According to this embodiment, strong hammering force can be applied to the needles by the power transmitting mechanism using the striker.

In addition or in the alternative to the preceding embodiments, the power transmitting mechanism may include an intermediate shaft and an oscillating member. The intermediate shaft may be operably connected to the output shaft and configured to rotate around a second rotational axis parallel to the first rotational axis along with rotation of the output shaft. The oscillating member may be arranged on the intermediate shaft and configured to oscillate in the front-rear direction along with rotation of the intermediate shaft. The reciprocating member may be operably connected to the oscillating member and configured to linearly reciprocate along the driving axis along with oscillation of the oscillating member.

According to this embodiment, the motion converting mechanism that converts rotary motion of the output shaft of the motor into linear motion of the reciprocating member is reduced in size, compared with a structure using a crank-piston mechanism.

In addition or in the alternative to the preceding embodiments, the reciprocating member may comprise a piston that forms an air chamber between the reciprocating member and the striker. The striker may reciprocate along the driving axis by pressure fluctuations caused in the air chamber by reciprocation of the piston.

According to this embodiment, the power transmitting mechanism reciprocates the striker by the action of air spring, or specifically by pressure fluctuations caused in the air chamber by reciprocation of the piston, and applies hammering force to the needles of the scaling mechanism. Therefore, the needle scaler is provided with excellent durability, compared with a structure in which the piston and the striker are connected by a mechanical spring in order to apply the hammering force.

In addition or in the alternative to the preceding embodiments, the piston may comprise a bottomed cylindrical piston cylinder. The striker may be slidable along the driving axis within the piston cylinder. The air chamber may be defined between a bottom of the piston cylinder and the striker.

According to this embodiment, the hammering mechanism is reduced in size, compared with a structure in which a cylindrical piston is arranged within a cylinder formed separately from the piston.

In addition or in the alternative to the preceding embodiments, the power transmitting mechanism may further include an elastic member that elastically connects the reciprocating member and the striker. The striker may reciprocate along the driving axis by an elastic force of the elastic member that is generated by reciprocation of the reciprocating member.

According to this embodiment, the power transmitting mechanism is realized with a relatively simple structure and the needle scaler is improved in productivity. Further, the hammering force of the striker can be adjusted by a simple way of adjusting the elastic force of the elastic member.

In addition or in the alternative to the preceding embodiments, the needle scaler may further include a sleeve that is arranged within the front end part of the tool body and holds the scaling mechanism. The front end part of the tool body may be made of synthetic resin. The sleeve may be made of metal and integrally formed with the front end part of the tool body. The scaling mechanism having the needles that move in the axial direction is easy to generate heat.

According to this embodiment, the tool body having the holding part (sleeve) that holds the scaling mechanism is provided with excellent durability, and the number of parts in assembling is reduced.

In addition or in the alternative to the preceding embodiments, the scaling mechanism may include a needle housing, a support and an anvil. The needle housing may have a front end having an opening through which the needles are inserted, and may be fixed to the tool body. The support may support the needles to be movable in the respective axial directions. The anvil may be arranged between the power transmitting part and the support in the front-rear direction. The anvil may be configured to apply the axial force to the needles by being struck by the power transmitting part. The support may have a bottomed cylindrical shape and include a bottom and a cylindrical peripheral wall. The bottom may have holes through which the needles are respectively inserted. The peripheral wall may extend rearward from an outer peripheral edge of the bottom and may be configured to slide in the front-rear direction along the driving axis within the needle housing. The anvil may include a large-diameter part and a small-diameter part. The large-diameter part may be configured to slide in the front-rear direction along the driving axis within the needle housing. The small-diameter part may protrude forward from the large-diameter part and have a smaller outer diameter than the large-diameter part. A rear end part of the peripheral wall of the support is configured to be fitted onto the small-diameter part of the anvil.

According to this embodiment, the anvil and the support substantially integrally slide within the needle housing, so that the anvil is restrained from tilting relative to the needle housing while the whole length of the anvil in the axial direction is reduced.

In addition or in the alternative to the preceding embodiments, one end part of each of the needles in the axial direction may be movable within a space that is defined between the bottom of the support and the anvil in the front-rear direction and surrounded by the peripheral wall of the support.

According to this embodiment, the space in which the needles can move in the axial direction is appropriately secured by the support and the anvil.

In addition or in the alternative to the preceding embodiments, the scaling mechanism may include a needle housing, a support, an anvil and an elastic element. The needle housing may have a front end having an opening through which the needles are inserted, and may be fixed to the tool body. The support may support the needles to be movable in the respective axial directions. The support may be configured to slide in the front-rear direction along the driving axis within the needle housing. The anvil may be arranged between the power transmitting part and the support in the front-rear direction and configured to slide in the front-rear direction along the driving axis within the needle housing. The anvil may be configured to apply hammering force to the needles by being struck by the power transmitting part. The elastic element may be disposed between the anvil and a rear end part of the needle housing in the front-rear direction.

According to this embodiment, the elastic element alleviates impact of collision when the needles are bounced back rearward and collide with the anvil.

In addition or in the alternative to the preceding embodiments, the needle scaler may further comprise a handle and an operation member. The handle may be connected to the tool body and include a grip part extending in a first direction crossing the driving axis. The operation member may be provided on a front side of the grip part and configured to be manually operated by a user to instruct start of the motor. The grip part may have a first end that is closer to the tool body and a second end that is farther from the tool body, in the first direction. The operation member may be arranged in a region of the grip part that includes at least a center position of the grip part that is substantially equidistant from the first and second ends in the first direction.

According to this embodiment, the operation member is arranged in a region including a center position in the first direction (or the longitudinal direction of the grip part). Thus, the operation member can be easily operated with one or more fingers of a user, whether the user holds the grip part in an orientation with a thumb on a first end side (on the end of the tool body side) of the grip part, or in an orientation with the thumb on a second end side (opposite side from the tool body) of the grip part. Further, the needle scaler can be used in various attitudes, but the orientation in which the grip part is held does not substantially affect the operability of the operation member, so that the needle scaler exhibits superior operability in various attitudes.

In addition or in the alternative to the preceding embodiments, the needle scaler may further comprise a lighting device that is arranged to illuminate an area forward of the needles.

According to this embodiment, workability in a dark place is improved.

Representative, non-limiting embodiments of the present disclosure are now specifically described with reference to the drawings.

### <First Embodiment>

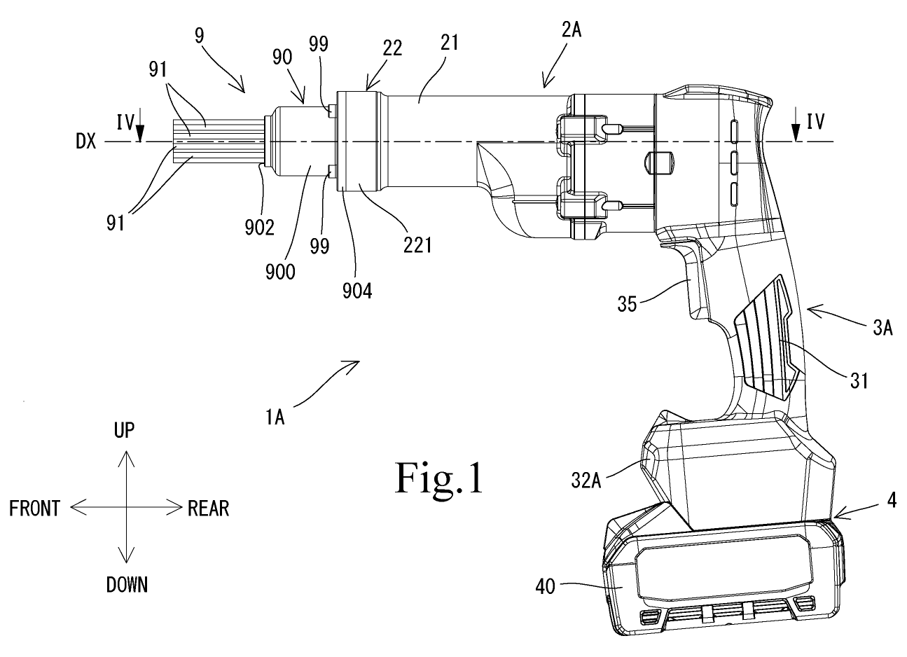

A needle scaler 1A according to a first embodiment of the present disclosure is now described with reference to FIGS. 1 to 6.

The needle scaler 1A is a relatively small portable power tool, which is also referred to as a needle gun scaler or a needle gun. The needle scaler 1A is configured to move elongate needles 91 in an axial direction to remove foreign matters (such as rust and paint) from a surface (hereinafter referred to as a working surface) of a workpiece with tips of the needles. The needles 91 can be replaced with other needles 91, but cannot be replaced with a tool accessory (such as a tool bit for crushing or chipping and a scraper for peeling) of a different kind from the needles 91. In other words, the needle scaler 1A of this embodiment is dedicated for operation using the needles 91.

First, the structure of the needle scaler 1A is described in brief.

As shown in FIGS. 1 to 3, an outer shell of the needle scaler 1A is defined by a tool body 2A extending along a driving axis DX and an elongate handle 3A protruding from the tool body 2A in a direction crossing the driving axis DX.

The tool body 2A houses a scaling mechanism 9 including the needles 91, an electric motor 51, and a hammering mechanism 6 that is operably connected to the motor 51 and applies hammering force to the scaling mechanism 9 when the motor 51 is driven. The scaling mechanism 9 is supported by one end part of the tool body 2A in the extending direction of the driving axis DX. The hammering mechanism 6 is configured to convert rotational power of the motor 51 into linear motion and apply hammering force to the scaling mechanism 9 by utilizing the action of air spring and thus move the needles 91 in the axial direction.

The handle 3A is a so-called pistol grip and is connected to the tool body 2A in a cantilever manner. Specifically, one end of the handle 3A in a longitudinal direction is connected as a base end to the tool body 2A, and the other end is a free end. In this embodiment, the handle 3A extends in a direction substantially orthogonal to the driving axis DX, from an end part of the tool body 2A on the opposite side from the scaling mechanism 9 in the extending direction of the driving axis DX. The handle 3A includes a grip part 31 configured to be held by a user, and a trigger 35 that is operated by a user to start the motor 51. When the trigger 35 is depressed, the motor 51 is driven, and the hammering mechanism 6 and thus the scaling mechanism 9 are operated.

The structure of the needle scaler 1A is now described in detail. In the following description, for convenience sake, the extending direction of the driving axis DX is defined as a front-rear direction of the needle scaler 1A. In the front-rear direction, the side of the scaling mechanism 9 is defined as the front side of the needle scaler 1A, and the opposite side (on which the handle 3A is connected) is defined as the rear side of the needle scaler 1A. A direction orthogonal to the driving axis DX and corresponding to the extending direction of the handle 3A is defined as an up-down direction of the needle scaler 1A. The up-down direction of the needle scaler 1A is not synonymous with a vertical direction. In the up-down direction, the side of the base end of the handle 3A is defined as an upper side of the needle scaler 1A, and the opposite side (the side of the free end) is defined as a lower side of the needle scaler 1A. A direction orthogonal to the front-rear direction and the up-down direction of the needle scaler 1A is defined as a left-right direction of the needle scaler 1A.

The structure of the tool body 2A is now described.

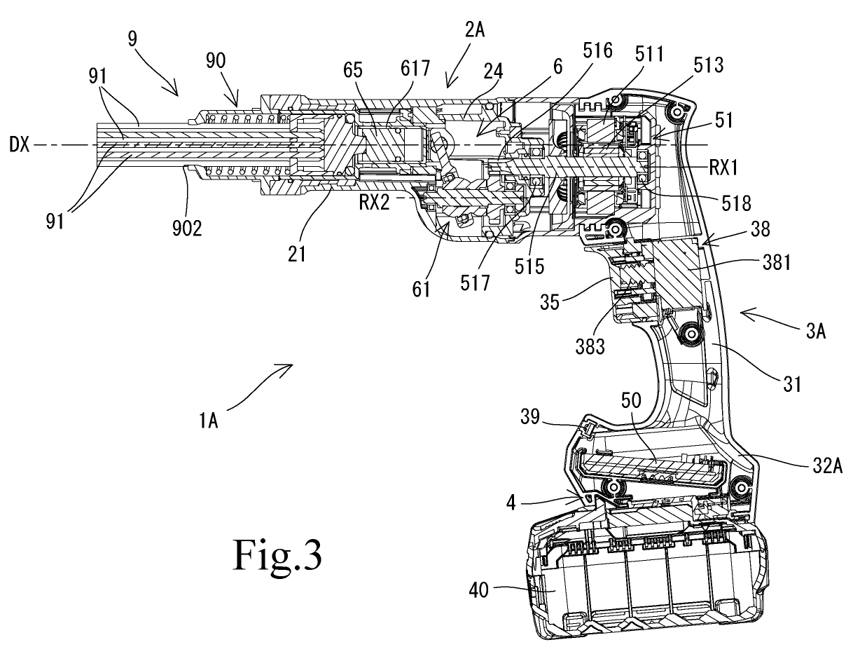

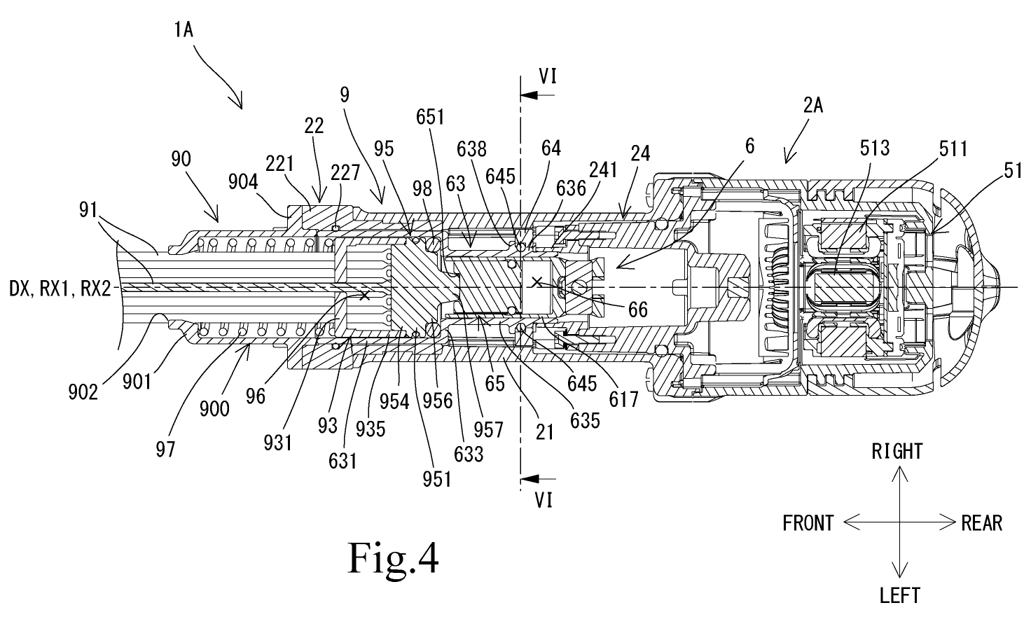

As shown in FIGS. 3 and 4, the tool body 2A is a hollow body extending along the driving axis DX. The tool body 2A of this embodiment is made of synthetic resin. A front part of the tool body 2A is also referred to as a barrel part 21, and has a circular cylindrical shape having a smaller diameter than a rear part of the tool body 2A extending rearward from the barrel part 21. The barrel part 21 extends along the driving axis DX. A user can use an auxiliary handle (not shown) that can be removably attached to the barrel part 21, as necessary. Alternatively, a user can hold the handle 3 with one hand and auxiliary hold the barrel part 21 with the other hand. The barrel part 21 houses part of the scaling mechanism 9 and part of the hammering mechanism 6. The rear part of the tool body 2A extending rearward from the barrel part 21 houses the motor 51 and part of the hammering mechanism 6.

A metal support 24 is fitted into the tool body 2A and supported to be substantially immovable relative to the tool body 2A. The support 24 partitions an inside space of the tool body 2A into a space in which the motor 51 is housed behind the support 24 and a space in which the hammering mechanism 6 is disposed in front of the support 24. Lubricant is filled in the space in front of the support 24. It can be said that the tool body 2A is an outer housing and the support 24 is an inner housing fixed within the outer housing.

Elements (mechanisms) disposed within the tool body 2A are now described.

First, the motor 51 is described. As shown in FIG. 3, the motor 51 is disposed within the rear end part of the tool body 2A. The motor 51 has a stator 511, a rotor 513 and an output shaft 515 that integrally rotates with the rotor 513. In this embodiment, the motor 51 is a brushless DC motor, but in other embodiments, the motor 51 may be a brush motor.

The output shaft 515 is rotatably supported at front and rear end parts by bearings 517, 518, respectively, and extends in the front-rear direction. The front bearing 517 is supported by the support 24. The front end part of the output shaft 515 protrudes into the space in front of the support 24, and a pinion 516 is formed in this part. The rear bearing 518 is supported by the tool body 2A. A rotational axis RX1 of the output shaft 515 extends in parallel to the driving axis DX below the driving axis DX.

The hammering mechanism 6 is now described. As shown in FIGS. 3 to 5, the hammering mechanism 6 is arranged in front of the motor 51 (specifically, substantially in a central part in the front-rear direction) within the tool body 2A. The hammering mechanism 6 includes an intermediate shaft 60, a motion converting mechanism 61 and a striker 65.

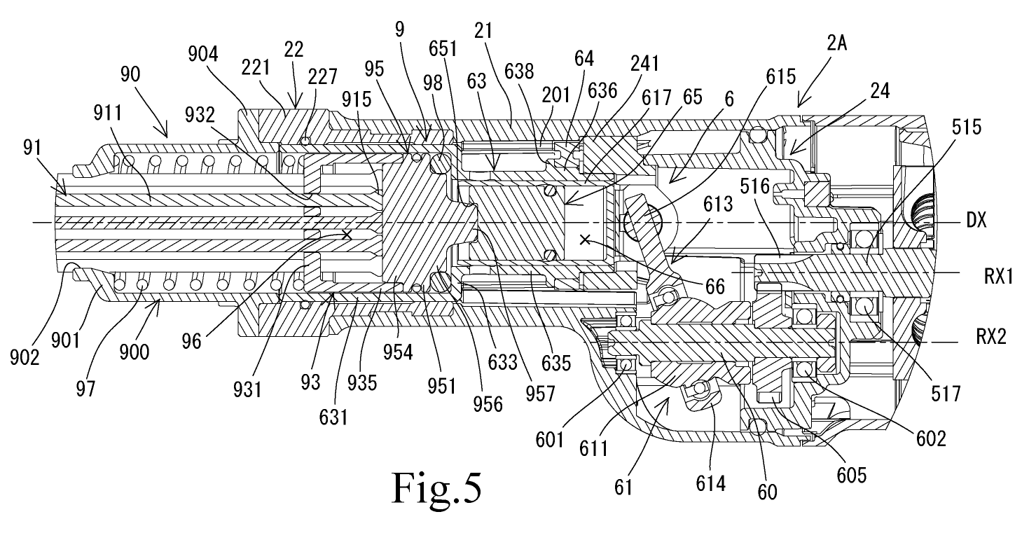

As shown in FIG. 5, the intermediate shaft 60 is rotatably supported at front and rear end parts by bearings 601, 602, respectively, and extends within a central part of the tool body 2A in the front-rear direction. The front bearing 601 is supported by the tool body 2A. The rear bearing 602 is supported by the support 24. A rotational axis RX2 of the intermediate shaft 60 extends in parallel to the driving axis DX and the rotational axis RX1 of the output shaft 515 below the rotational axis RX1. With this arrangement, the distance (so-called center height) between the driving axis DX and an upper surface of the tool body 2A can be made significantly shorter than the distance between the driving axis DX and a lower surface of the tool body 2A. In this embodiment, the driving axis DX and the rotational axes RX1, RX2 are arranged on a plane that substantially divides the tool body 2A into two halves in the left-right direction.

The intermediate shaft 60 is operably connected to the output shaft 515 of the motor 51. More specifically, a gear 605 is fixedly fitted onto a rear end part of the intermediate shaft 60 and engaged with the pinion 516 formed on the front end part of the output shaft 515. Thus, the intermediate shaft 60 is rotated along with rotation of the output shaft 515.

The motion converting mechanism 61 includes a rotary body 611 that is arranged on the intermediate shaft 60, an oscillating member 613 that is operably connected to the rotary body 611, and a piston cylinder 617 that is operably connected to the oscillating member 613.

The rotary body 611 is fitted onto the intermediate shaft 60 in front of the gear 605 so as to be integrally rotated with the intermediate shaft 60. The oscillating member 613 includes a ring part 614 that is fitted onto the rotary body 611, and an arm part 615 extending from the ring part 614. The rotary body 611 and the oscillating member 613 are configured such that the arm part 615 is oscillated in the front-rear direction along with rotation of the intermediate shaft 60 and the rotary body 611. In this embodiment, the rotary body 611 and the oscillating member 613 are connected via rolling elements and integrally formed as an assembly that is called a swash bearing, a wobble bearing or a wobble plate. The rotary body 611 and the oscillating member 613 can however be appropriately changed in structure, provided that rotation of the intermediate shaft 60 can be converted into linear motion in the front-rear direction and transmitted to the piston cylinder 617. For example, the rotary body 611 may be integrally formed with the intermediate shaft 60.

The piston cylinder 617 is a circular bottomed cylindrical member. The piston cylinder 617 is arranged with an opening facing forward within a rear half part of a cylinder 63. The cylinder 63 of this embodiment is a cylindrical stepped member and has a front half part having a larger inner diameter and a larger outer diameter than the rear half part of the cylinder 63. The front and rear half parts of the cylinder 63 are hereinafter referred to as a large-diameter part 631 and a small-diameter part 635, respectively. A part connecting a rear end of the large-diameter part 631 and a front end of the small-diameter part 635 is referred to as a shoulder part 633. The cylinder 63 is fixedly held within the tool body 2A. The mechanism for holding the cylinder 63 will be described in detail below.

The piston cylinder 617 is configured to slide within the small-diameter part 635 of the cylinder 63 in the front-rear direction along the driving axis DX. Thus, the small-diameter part 635 of the cylinder 63 is configured as a sliding guide for the piston cylinder 617. A rear end part of the piston cylinder 617 is operably connected to the arm part 615 of the oscillating member 613. Thus, the piston cylinder 617 is reciprocally slid in the front-rear direction along with oscillation of the arm part 615.

The striker 65 is a striking element that is configured to apply hammering force to the needles 91 by striking an anvil 95 (described below) of the scaling mechanism 9 along with reciprocation of the piston cylinder 617. The striker 65 is a cylindrical member and is arranged within the piston cylinder 617 so as to be slidable along the driving axis DX. A space between the bottom of the piston cylinder 617 and the striker 65 defines an air chamber 66 that functions as an air spring. The striker 65 is reciprocally slid within the piston cylinder 617 by pressure fluctuations caused in the air chamber 66 by the reciprocation of the piston cylinder 617. A recess 651 having a circular section is formed in a central part of a front end surface of the striker 65.

The holding mechanism for the cylinder 63 is now described.

As shown in FIGS. 4 and 5, the cylinder 63 is supported within the tool body 2A so as to be substantially immovable in the front-rear direction relative to the tool body 2A. More specifically, the rear end part of the small-diameter part 635 of the cylinder 63 is fitted onto a cylindrical part 241 formed on an upper front end part of the support 24. A small flange 636 is formed on a rear part of the small-diameter part 635 and protrudes radially outward. A front end of the cylindrical part 241 of the support 24 abuts on the small flange 636 via a washer and prevents further rearward movement of the cylinder 63.

The large-diameter part 631 of the cylinder 63 is fitted into a cylindrical sleeve 22 fixed to the barrel part 21. A front part of the sleeve 22 is configured as a flange 221 and has a larger diameter than the other part of the sleeve 22. The flange 221 of the sleeve 22 is arranged in front of a front end of the barrel part 21, and a part (small-diameter part) extending rearward of the flange 221 is arranged within the barrel part 21. In this embodiment, the sleeve 22 is made of metal and integrally formed with the barrel part 21 made of synthetic resin. Thus, the sleeve 22 and the barrel part 21 are formed as a single member that cannot be substantially separated from each other. The sleeve 22 may therefore be considered as part of the tool body 2A.

Although the details will be described later below, the large-diameter part 631 of the cylinder 63 is part of a needle housing 90 of the scaling mechanism 9. When the scaling mechanism 9 is driven, a support 93 and an anvil 95 slide within the large-diameter part 631, so that the large-diameter part 631 generates heat. Thus, the durability of the tool body 2A is enhanced by providing the metal sleeve 22 for holding the large-diameter part 631 like in this embodiment. Further, the number of parts in assembling is reduced by integrally forming the sleeve 22 with the tool body 2A. In other embodiments, however, the sleeve 22 may be separately formed from the tool body 2A and then fixed within the tool body 2A. Alternatively, the sleeve 22 may be omitted.

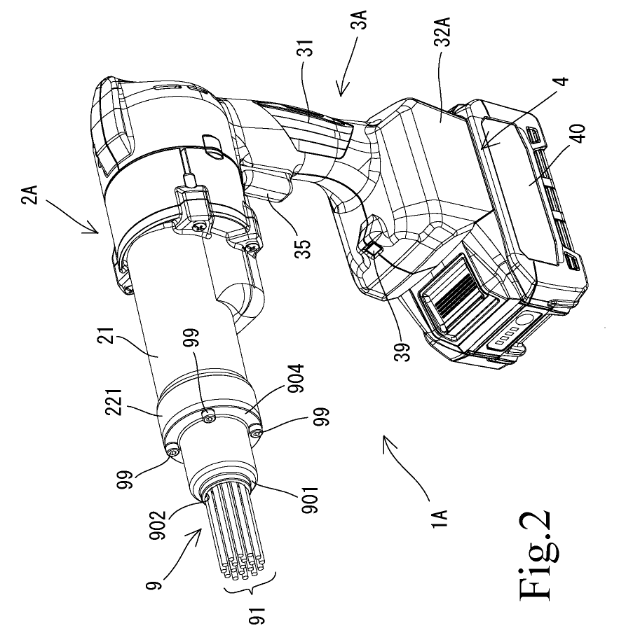

Although the details will be described later below, a cylindrical member 900, which is another part of the needle housing 90, is fixed to the sleeve 22 with a screw 99 (see FIG. 2) from the front. A rear end of the cylindrical member 900 abuts on a front end of the large-diameter part 631 and prevents further forward movement of the cylinder 63.

An annular groove is formed in an inner peripheral surface of a front end part of the sleeve 22, and an annular elastic element (O-ring) 227 for sealing is fitted in the groove. The elastic element 227 seals a gap between an inner peripheral surface of the sleeve 22 and the large-diameter part 631 of the cylinder 63 and thus reduces the possibility of leakage of lubricants from the tool body 2A to the outside.

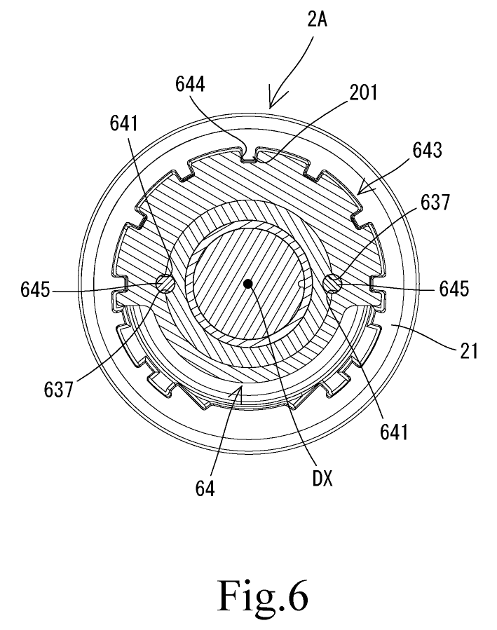

As shown in FIGS. 4 and 6, the cylinder 63 and the tool body 2A are unrotatably connected to each other via a rotation stopper ring 64. The rotation stopper ring 64 is a ring-like (annular) member and is fitted onto a rear end part (specifically, the small flange 636 of the small-diameter part 635) of the cylinder 63.

Two recesses 641 are formed in an inner peripheral surface of the rotation stopper ring 64 and arranged opposite to each other across the driving axis DX. The recesses 641 have a semispherical section and extend from a front end to a central part of the rotation stopper ring 64 in the font-rear direction. Two semispherical recesses 637 are formed corresponding to the recesses 641 of the rotation stopper ring 64 in an outer peripheral surface of the small flange 636 of the small-diameter part 635. The cylinder 63 and the rotation stopper ring 64 are connected so as not to be rotatable around the driving axis DX relative to each other, via balls 645 respectively disposed in the recesses 637, 641. A large flange 638 having a larger diameter than the small flange 636 of the cylinder 63 is disposed in front of the small flange 636. The rotation stopper ring 64 is held between the large flange 638 and the washer disposed in front of the cylindrical part 241 of the support 24.

A projection 643 is formed on about a half of an outer periphery of the rotation stopper ring 64 and protrudes radially outward in a circular arc shape. Grooves 644 are formed in an outer peripheral surface of the projection 643 and arranged apart from each other. The grooves 644 have a rectangular section and extend from a front end to a rear end of the rotation stopper ring 64. Projections 201 are formed corresponding to the grooves 644 in an inner peripheral surface of an upper half part of a rear part of the barrel part 21. The projections 201 have a rectangular section and extend in the font-rear direction. The tool body 2A and the rotation stopper ring 64 are connected so as not to be rotatable around the driving axis DX relative to each other, by engagement between the projections 201 and the grooves 644.

As described above, the needle scaler 1A is dedicated for operation using the needles 91. In such a dedicated tool, the needles 91 may just be movable in the axial direction (substantially in the front-rear direction) relative to the tool body 2A, and from the viewpoint of working efficiency, it is rather preferred that the scaling mechanism 9 is configured not to be rotated. Therefore, in this embodiment, the cylinder 63 is supported to be substantially unrotatable relative to the tool body 2A via the rotation stopper ring 64. In other embodiments, however, the rotation stopper ring 64 may be omitted.

The scaling mechanism 9 is now described. As shown in FIGS. 4 and 5, the scaling mechanism 9 is supported in a front half part of the barrel part 21 of the tool bod 2A. The scaling mechanism 9 of this embodiment includes the needle housing 90, the support 93, the needles 91 supported by the support 93, and the anvil 95 that transmits the hammering force to the needles 91.

The needle housing 90 has a cylindrical shape, and is supported coaxially with the cylinder 63 by the front half part of the barrel part 21. The needle housing 90 houses the support 93, the anvil 95 and part of the needles 91. In this embodiment, the needle housing 90 includes the large-diameter part 631 and the shoulder part 633 of the cylinder 63 and the cylindrical member 900 separate from the cylinder 63.

A front end of the cylindrical member 900 has an annular wall 901 protruding radially inward. An inner periphery of the wall 901 defines a front end opening 902 of the needle housing 90. A flange 904 is formed on a rear end part of the cylindrical member 900 and protrudes radially outward. The cylindrical member 900 is fixed to the sleeve 22 and thus the tool body 2A by the screw 99 being inserted through a hole of the flange 904 and screwed into a screw hole of the flange 221 of the sleeve 22 (see FIG. 2). The needles 91 can be replaced by removing the screw 99 and the cylindrical member 900.

The large-diameter part 631 of the cylinder 63 and the cylindrical member 900 have substantially the same inner diameter, and are arranged such that the rear end of the cylindrical member 900 abuts on the front end of the large-diameter part 631 of the cylinder 63. With this arrangement, the large-diameter part 631 and the shoulder part 633 of the cylinder 63 form a rear half part of the needle housing 90, and the cylindrical member 900 forms a front half part of the needle housing 90.

Each of the needles 91 includes an elongate cylindrical (round rod-like) body 911 and a head 915 formed on one end of the body 911 in the axial direction. In this embodiment, the head 915 has a truncated conical shape having a diameter decreasing toward the other end of the body 911 in the axial direction (a tip of the needle 91).

The support 93 supports the needles 91 to be movable in the axial direction of the needles 91. The support 93 is arranged within the needle housing 90 so as to be slidable in the front-rear direction along the driving axis DX. More specifically, the support 93 is a bottomed cylindrical member having a slightly smaller outer diameter than the needle housing 90, and includes a circular bottom 931 and a cylindrical peripheral wall 935 extending in the axial direction of the support 93 from a peripheral edge of the bottom 931. The support 93 is arranged coaxially with the needle housing 90 within the needle housing 90 in such a direction that the peripheral wall 935 extends rearward from the bottom 931.

The bottom 931 has holes 932 formed through the bottom 931 in the front-rear direction. Each of the holes 932 has a rear end part that is configured to come into surface contact with part of the head 915 of the needle 91 when the needle 91 moves forward. The other part (other than the rear end part) of the hole 932 has a diameter large enough to allow the body 911 of the needle 91 to slide therethrough.

The needle 91 is inserted through the hole 932 from behind the bottom 931, with the head 915 on the rear side. Although slightly tilted, the needle 91 moves substantially in the front-rear direction of the needle scaler 1A, while the body 911 slides within the hole 932. The needle 91 can slide up to a position where the head 915 abuts on the rear end part of the hole 932, relative to the support 93 in the axial direction of the needle 91. Part of the needle 91 including the tip (front end) of the needle 91 always protrudes forward of the needle housing 90 from the front end opening 902 of the needle housing 90.

The anvil 95 is arranged between the striker 65 of the hammering mechanism 6 and the support 93 in the front-rear direction. The anvil 95 can be slid in the front-rear direction along the driving axis DX within the needle housing 90. More specifically, the anvil 95 is a cylindrical stepped member as a whole and is arranged coaxially with the needle housing 90 within the needle housing 90. The anvil 95 includes a large-diameter part 951, a front small-diameter part 954, a rear small-diameter part 956 and a rear projection 957.

The large-diameter part 951 is a central part of the anvil 95 in the axial direction (the front-rear direction) and has the largest diameter in the anvil 95. The large-diameter part 951 is configured to slide within the needle housing 90. The large-diameter part 951 may also be referred to as a sliding part.

The front small-diameter part 954 protrudes forward from the large-diameter part 951 and has a smaller diameter than the large-diameter part 951. Thus, the large-diameter part 951 protrudes radially outward of the front small-diameter part 954 in a flange-like form behind the front small-diameter part 954. The diameter of the front small-diameter part 954 is slightly smaller than the inner diameter of the peripheral wall 935 of the support 93. Therefore, the rear end part of the peripheral wall 935 of the support 93 can slide in the front-rear direction relative to the front small-diameter part 954 while being fitted onto the front small-diameter part 954. Thus, the anvil 95 and the support 93 substantially integrally slide within the needle housing 90, so that the anvil 95 is restrained from tilting relative to the needle housing 90 while the whole length of the anvil 95 in the axial direction is reduced.

With such structure, a cylindrical space 96 is defined between the bottom 931 of the support 93 and the front small-diameter part 954 radially inside of the peripheral wall 935 and in the front-rear direction. The rear end part of the needle 91 can move in the front-rear direction within the space 96. A front surface of the front small-diameter part 954 collides with a rear surface of the head 915 and applies hammering force to the needles 91.

The rear small-diameter part 956 protrudes rearward from the large-diameter part 951 and has a smaller diameter than the large-diameter part 951. An annular elastic element (O-ring) 98 is fitted onto the rear small-diameter part 956. Thus, in the radial direction, the elastic element 98 is disposed between the anvil 95 (specifically, the rear small-diameter part 956) and the needle housing 90 (specifically, the rear half part). Further, in the front-rear direction, the elastic element 98 is disposed between the anvil 95 (specifically, the large-diameter part 951) and the rear end part of the needle housing 90 (specifically, the shoulder part 633 of the cylinder 63).

The rear projection 957 protrudes rearward from the rear small-diameter part 956. The diameter of the rear projection 957 is set smaller than the diameter of the recess 651 formed in the front end surface of the striker 65. Although the details will be described later below, in this embodiment, when the hammering mechanism 6 is driven, the rear projection 957 is directly struck by the striker 65 arranged within the small-diameter part 635 of the cylinder 63. A rear end surface of the rear projection 957 receives the hammering force from the striker 65. In other embodiments, the rear projection 957 of the anvil 95 may be omitted, and the front surface of the striker 65 may collide with a rear surface of the rear small-diameter part 956. Alternatively, a projection may be formed on the striker 65 and protrude forward, and a front surface of the projection may collide with the anvil 95.

Further, the scaling mechanism 9 of this embodiment includes a biasing member 97 that is disposed between the front end wall 901 of the needle housing 90 and the support 93 in the front-rear direction. The biasing member 97 of this embodiment is a compression coil spring. The biasing member 97 biases the support 93 rearward relative to the needle housing 90 and thus the tool body 2A. As described above, the rear end part of the peripheral wall 935 of the support 93 is fitted onto the front small-diameter part 954. The rear end of the peripheral wall 935 abuts on the front end surface of the large-diameter part 951 of the anvil 95 by the biasing force of the biasing member 97, and the anvil 95 is also biased rearward relative to the needle housing 90.

The handle 3A and elements (mechanisms) disposed therein are now described.

As shown in FIGS. 1 to 3, the handle 3A is an elongate hollow body protruding downward from the rear end part of the tool body 2A. The handle 3A includes a grip part 31 configured to be held by a user. The grip part 31 has a diameter suitable for a user to hold, and has a length slightly longer than the average width of a hand of an adult male. In this embodiment, the whole handle 3A except for a lower end part 32 forms the grip part 31.

The trigger 35 is arranged on the front side of the grip part 31. The trigger 35 is a manual operation member that is configured to be depressed by a user to start the motor 51. In this embodiment, the trigger 35 is supported by an upper end part of the grip part 31 so as to be linearly slidable substantially in the front-rear direction (the extending direction of the driving axis DX).

A switch 38 is arranged just behind the trigger 35 within the grip part 31. The switch 38 is configured to be turned on and off according to the depressing operation of the trigger 35. The switch 38 of this embodiment has a switch body 381 and a plunger 383 biased forward and protruding forward from the switch body 381. A protruding end of the plunger 383 is held in contact with the trigger 35. The switch 38 is configured to be normally kept off, and turned on when the plunger 383 is pushed into the switch body 381. The switch 38 is electrically connected to a controller 50 (described below).

In an initial state in which the trigger 35 is biased forward by the plunger 383 and not subjected to rearward external force, the trigger 35 is held in a frontmost position. When the trigger 35 is located in the frontmost position, the switch 38 is in an off state. When the trigger 35 is depressed and slid rearward to a prescribed position while pushing in the plunger 383, the switch 38 is tuned on.

A lower end part 32A of the handle 3A has a rectangular box-like shape larger than the diameter of the grip part 31. A lighting unit 39 is arranged on the front side of the lower end part 32A. The lighting unit 39 includes a light source (such an LED) and is supported by the lower end part 32A to illuminate a working area of the needles 91 (i.e. an area in front of the barrel part 21). Specifically, the lighting unit 39 is arranged to illuminate diagonally forward and upward through an opening formed in the lower end part 32A.

The controller 50 is disposed within the lower end part 32A. The controller 50 includes at least one processor (such as a CPU) or processing circuit and controls operation of the needle scaler 1A. In this embodiment, the controller 50 controls driving of the motor 51 and driving of the lighting unit 39. More specifically, the controller 50 drives the motor 51 and lights the lighting unit 39 while the switch 38 is in an on state.

A battery mounting part 4 to which a battery 40 as a power source can be mounted is provided in the lower end part 32A of the handle 3A. The battery 40 is mounted to the battery mounting part 4 and most of the battery 40 is exposed below the lower end part 32A of the handle 3A. The structure of the battery 40 is well known and therefore not shown and described in detail in this embodiment. In other embodiments, the power source of the needle scaler 1A may be an external AC power source instead of the battery 40.

Operation of the needle scaler 1A is now described.

A user holds the grip part 31 and places the tips of the needles 91 in the vicinity of the working surface. When the user depresses the trigger 35, the motor 51 is driven and the hammering mechanism 6 is operated to apply hammering force to the scaling mechanism 9. Specifically, the air pressure inside the air chamber 66 fluctuates along with reciprocation of the piston cylinder 617, so that the striker 65 is slid in the front-rear direction within the piston cylinder 617. More specifically, when the piston cylinder 617 is moved forward, air of the air chamber 66 is compressed, so that the internal pressure increases. Then the striker 65 moves forward at high speed by the action of the air spring and collides with the anvil 95.

The anvil 95 transmits the kinetic energy of the striker 65 to the support 93 that abuts on the front end surface of the large-diameter part 951 of the anvil 95. The anvil 95 and the support 93 move forward against the biasing force of the biasing member 97. The front surface of the anvil 95 strikes the heads 915 of the needles 91, so that hammering force is applied to the needles 91. The needles 91 move in the axial direction, and the tips of the needles 91 collide with a workpiece and thereby remove foreign matters from a working surface of the workpiece. When the needles 91 are bounced back rearward by reaction of the collision with the workpiece, the needles 91 collide with the anvil 95. At this time, the elastic element 98 disposed between the rear surface of the large-diameter part 951 of the anvil 95 and the rear end part of the needle housing 90 (the shoulder part 633) alleviates the impact of the collision.

As described above, the needle scaler 1A of this embodiment has the hammering mechanism 6 that is driven by power of the electric motor 51. The hammering mechanism 6 reciprocates the striker 65 by the action of air spring, or specifically by pressure fluctuations caused in the air chamber 66 by reciprocation of the piston, and applies hammering force to the needles 91 of the scaling mechanism 9. Therefore, the needle scaler 1A of this embodiment is provided with excellent durability, compared with a structure in which the piston and the striker are connected by a mechanical spring (such as a compression coil spring) to apply the hammering force.

### <Second Embodiment>

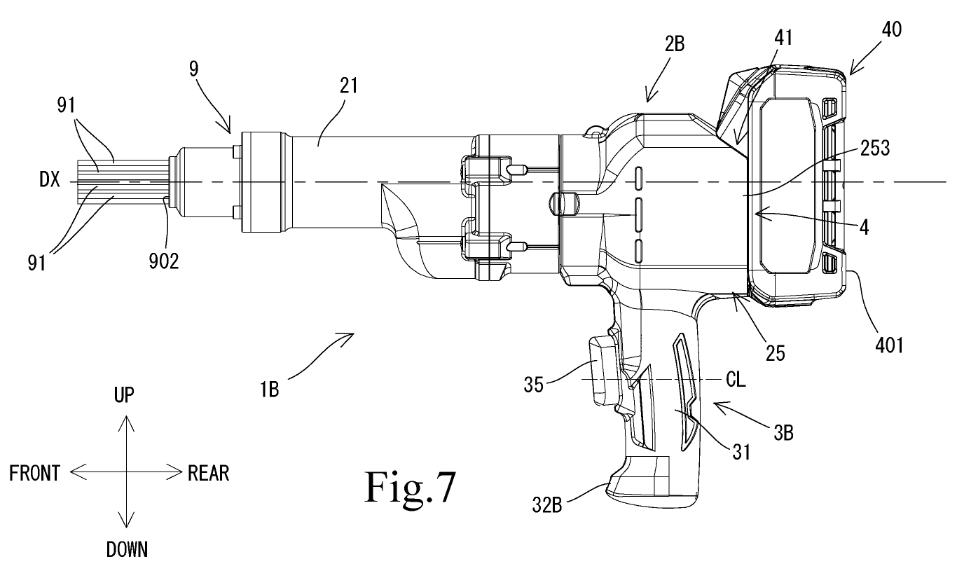

A needle scaler 1B according to a second embodiment of the present disclosure is now described with reference to FIGS. 7 to 11. The needle scaler 1B is different from the needle scaler 1A of the first embodiment mainly in the structures of a tool body 2B and a handle 3B, but otherwise it has substantially the same structure as the needle scaler 1A. Therefore, in the following description, components or structures substantially identical to those of the first embodiment are given like reference numerals, and are not described or only simply described. The structures different from the first embodiment are now mainly described.

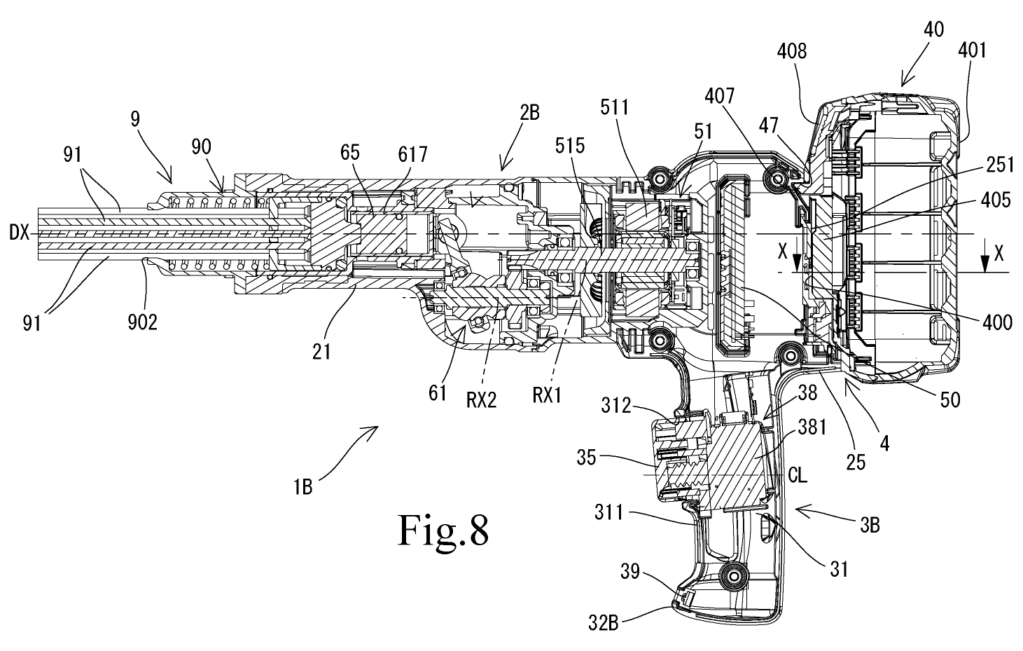

As shown in FIGS. 7 and 8, the needle scaler 1B of this embodiment has a tool body 2B that extends along the driving axis DX and houses the motor 51, the hammering mechanism 6 and the scaling mechanism 9. In this embodiment, a handle 3B is connected to a rear end part 25 of the tool body 2B in a cantilever manner and extends from a lower end of the rear end part 25 in a direction substantially orthogonal to the driving axis DX.

The tool body 2B and elements (mechanisms) disposed therein are first described. The tool body 2B of this embodiment is different from the tool body 2A of the first embodiment mainly in that the battery mounting part 4 is provided in the rear end part 25 and the controller 50 is housed in the rear end part 25.

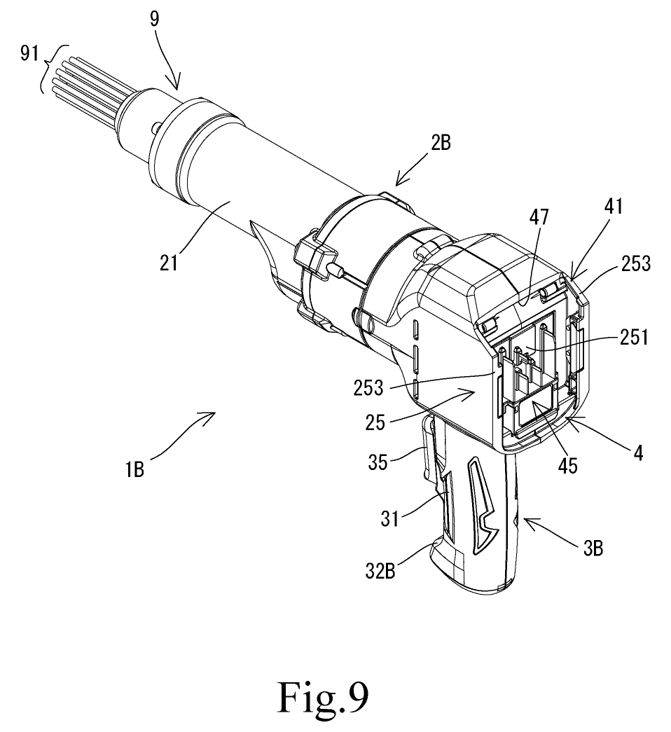

As shown in FIGS. 8 and 9, the rear end part 25 of the tool body 2B has a rectangular box-like shape. Side wall parts 253 of the rear end part 25 protrude rearward of a rear wall part 251 of the tool body 2B. In this embodiment, the rear wall part 251 is a generally rectangular wall having a rear surface substantially orthogonal to the driving axis DX. In other embodiments, however, the rear wall part 251 may be inclined to the driving axis DX. The battery mounting part 4 to which the battery 40 can be mounted is provided in the lower end part 25.

The detailed structures of the battery 40 and the battery mounting part 4 of this embodiment are now described.

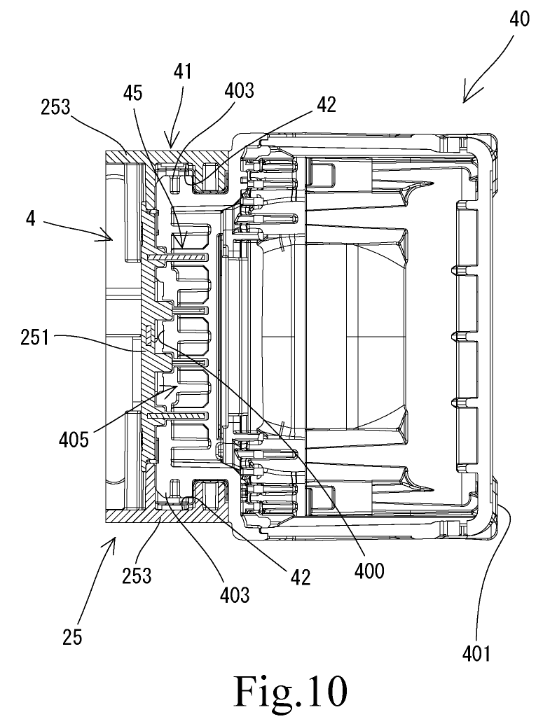

The battery 40 is a rechargeable battery (also referred to as battery pack) and can be mounted to plural kinds of power tools including the needle scaler 1B. As shown in FIGS. 8 and 10, the battery 40 has a generally rectangular parallelepiped (hexahedral) shape. A pair of guide rails 403 and a connector part 405 having terminals are provided on one surface (hereinafter referred to as a mounting surface 400) of the battery 40. The guide rails 403 protrude from the mounting surface 400 and extend parallel to each other in a longitudinal direction of the battery 40. The connector part 405 is arranged between the guide rails 403. A direction in which the guide rails 403 face each other defines a width direction of the battery 40. A direction substantially orthogonal to the mounting surface 400 defines a height direction of the battery 40.

As shown in FIGS. 8 to 10, the battery mounting part 4 includes an engagement part 41 that can be physically engaged with the battery 40, and a connector part 45 that can be electrically connected to the battery 40. The engagement part 41 includes a pair of guide grooves 42 respectively formed in the side wall parts 253. The guide grooves 42 are long linear grooves respectively formed in inner surfaces of the side wall parts 253. The guide grooves 42 extend downward in the up-down direction in parallel to each other from an upper end of the side wall parts 253. The guide grooves 42 are configured to be slidingly engaged with the guide rails 403 of the battery 40. The connector part 45 is arranged on the rear wall part 251 (between the guide grooves 42). The connector part 45 includes terminals that can be respectively electrically connected to the terminals of the battery 40.

In order to mount the battery 40 to the battery mounting part 4, the guide rails 403 of the battery 40 are fitted into the guide grooves 42 of the battery mounting part 4 from above, while the battery 40 is held with the guide rails 403 extending in the up-down direction of the needle scaler 1B. Specifically, in this embodiment, a direction of mounting the battery 40 to the battery mounting part 4 substantially corresponds to the downward direction of the needle scaler 1B. When the battery 40 is slid downward to a prescribed mounting position, the connector part 405 (the terminals) of the battery 40 is electrically connected to the connector part 45 (the terminals) and mounting of the battery 28 is completed.

A recessed part 47 is formed in an upper end part of the battery mounting part 4 (above the connector part 45) and configured to be engaged with a locking member 407 (see FIG. 8) provided on the mounting surface 400 of the battery 40. When the battery 40 is placed at the mounting position, the locking member 407 is engaged with the recessed part 47 and restricts movement of the battery 40 in the up-down direction relative to the battery mounting part 4.

When the battery 40 is mounted to the battery mounting part 4, the rear wall part 251 faces the mounting surface 400 of the battery 40. In this embodiment, the driving axis DX passes through the battery mounting part 4 (specifically, the rear wall part 251) and the battery 40. Thus, the driving axis DX passes through the battery mounting part 4 (specifically, the rear wall part 251) and the battery 40, when the needle scaler 1B is viewed from a direction orthogonal to the driving axis DX and a longitudinal axis of the handle 3B (the grip part 31) (specifically, from the left or right). Further, the driving axis DX also passes through the battery mounting part 4 and the battery 40, when the needle scaler 1B is viewed from the longitudinal direction of the handle 3B (specifically, from above or below). In this embodiment, the driving axis DX passes through the centers of the battery mounting part 4 and the battery 40 in the left-right direction.

In order to remove the battery 40 from the battery mounting part 4, a release button 408 (see FIG. 8), which is provided adjacent to the locking member 407 on the battery 40, is depressed to disengage the locking member 407 from the recessed part 47. Subsequently, the battery 40 is lifted upward and removed while the guide rails 403 are slid in the guide grooves 42. Specifically, in this embodiment, a direction of removing the battery 40 from the battery mounting part 4 is defined as the upward direction of the needle scaler 1B.

In this embodiment, the guide grooves 42 of the battery mounting part 4 extend in the up-down direction, and thus the longitudinal direction of the battery 40 placed in the mounting position substantially corresponds to the up-down direction of the needle scaler 1B. Therefore, the whole length of the tool body 2B with the battery 40 mounted thereon in the front-rear direction is reduced, compared with a structure in which the guide grooves 42 extend in the front-rear direction in parallel to the driving axis DX. Further, the guide grooves 42 are arranged in symmetry to a plane including the driving axis DX and the longitudinal axis of the handle 3B, and the mounted battery 40 also has a substantially symmetrical shape to the plane. Thus, the tool body 2B with the battery 40 mounted thereto is well-balanced in the left-right direction.

Further, the guide grooves 42 are configured to receive the battery 40 from above. Thus, the battery 40 placed in the mounting position relatively greatly protrudes upward from the battery mounting part 4, but little protrudes downward from the battery mounting part 4. Various kinds of batteries 40 different in size (particularly, length and height) can be mounted to the battery mounting part 4. The amount of upward protrusion of the batteries 40 from the battery mounting part 4 is different according to the kind of the batteries 40, but any battery 40 little protrudes downward from the battery mounting part 4.

As shown in FIG. 8, the arrangement of the motor 51, the hammering mechanism 6 and the scaling mechanism 9 in the tool body 2B is the same as in the first embodiment. In this embodiment, however, the controller 50 is not arranged within the handle 3B, but within the rear end part 25 of the tool body 2B. More specifically, the controller 50 is arranged between the motor 51 and the battery mounting part 4 in the front-rear direction. The driving axis DX passes through the motor 51 and the controller 50 as well as through the battery mounting part 4.

The handle 3B and elements (mechanisms) disposed therein are now described.

As shown in FIGS. 7 and 8, the handle 3B of this embodiment is different from the handle 3A of the first embodiment mainly in the structure of a lower end part 32B and in that the trigger 35 is arranged in a central region of the grip part 31 in the longitudinal direction.

The handle 3B is an elongate hollow body including a grip part 31. The whole handle 3B except for the lower end part 32B forms the grip part 31.

The handle 3B of this embodiment extends downward from a lower end of a part of the tool body 2B that is located slightly forward of the battery mounting part 4 in the front-rear direction. Thus, the handle 3B is arranged on the same side as the rotational axis RX1 of the output shaft 515 and the rotational axis RX2 of the intermediate shaft 60 relative to the driving axis DX in the up-down direction. Further, in this embodiment, the handle 3B is arranged rearward of the stator 511 of the motor 51 and the hammering mechanism 6 and forward of the battery mounting part 4 in the front-rear direction. The controller 50 is arranged in a region just above the grip part 31 within the tool body 2B.

As described above, in this embodiment, the battery 40 mounted to the battery mounting part 4 little protrudes downward from the battery mounting part 4. An area just below the battery 40 and just behind the grip part 31 is secured as a space area (where nothing exists) for a hand of the user to hold the grip part 31.

The lower end part 32B of the handle 3B does not have a rectangular box-like shape like in the first embodiment, but only protrudes slightly forward from the grip part 31. The lighting unit 39 is arranged in this protruding part. The lighting unit 39 is supported by the lower end part 32B to illuminate a working area of the needles 91.

The trigger 35 is arranged on the front side of the grip part 31. In this embodiment, the trigger 35 is arranged in a region including the center position CL of the grip part 31 in the longitudinal direction (substantially in the up-down direction of the needle scaler 1B). The center position CL is a position substantially equidistant from both ends (i.e. an upper end close to the tool body 2B, which is also the base end of the handle 3B, and a lower end close to the free end of the handle 3B) of a front surface of the grip part 31 in the longitudinal direction of the grip part 31. More specifically, the trigger 35 is arranged in a central region of the grip part 31 in the longitudinal direction and away from the upper and lower ends of the front surface of the grip part 31. This central region is a region including the center position CL of the grip part 31 in the longitudinal direction.

The trigger 35 of this embodiment is supported by the grip part 31 so as to be linearly slidable substantially in the front-rear direction (the extending direction of the driving axis DX). More specifically, an opening 312 is formed in the front wall part 311 that defines the front surface of the grip part 31. The trigger 35 is arranged to partially protrude from the front wall part 311 through the opening 312. A switch 38 is arranged just behind the trigger 35 within the grip part 31. The trigger 35 can be moved in the front-rear direction while sliding on plate-like guides, which protrude rearward from the front wall part 311 on the upper and lower sides of the opening 312, respectively, and sliding on a plate-like guide formed on the switch 38.

As described above, the needle scaler 1B of this embodiment has the handle 3B that protrudes in a direction crossing the driving axis DX from the tool body 2B extending along the driving axis DX. The trigger 35 is configured to be depressed to instruct start of the motor 51 and arranged in a region including the center position CL of the grip part 31 in the longitudinal direction. Thus, the trigger 35 can be easily depressed with one or more fingers of a user, whether the user holds the grip part 31 in an orientation with a thumb on the upper end side (the tool body 2B side) of the grip part 31 (hereinafter referred to as a normal orientation), or in an orientation with the thumb on the lower end side (the lower end part 32B side) of the grip part 31 (hereinafter referred to as a reverse orientation).

In the needle scaler 1A of the first embodiment, the trigger 35 is arranged in the upper end part of the grip part 31. This arrangement is suitable for a user to hold the grip part 31 in the normal orientation and depress the trigger 35 with a forefinger. When holding the grip part 31 in the reverse orientation, however, the user needs to depress the trigger 35 with a little finger, so that it is difficult to apply a sufficient depressing force to the trigger 35. In the needle scaler 1B of this embodiment, the user can apply substantially equal depressing force to the trigger 35 whether the grip part 31 is held in the normal orientation or in the reverse orientation.

Further, the trigger 35 is arranged away from the upper and lower ends of the grip part 31 and supported to be slidable in the front-rear direction. Thus, with a simple structure, the trigger 35 is provided that can be easily operated by a user holding the grip part 31 whether in the normal orientation or in the reverse orientation.

Although not described in detail and shown, in another embodiment, an elongate switch lever may be provided in place of the trigger 35. The switch lever is rotatably supported at one end part by a lower end part or an upper end part of the grip part 31 and configured to extend to a position beyond the center position CL of the grip part 31 (or to have a length longer than half the length of the grip part 31 in the longitudinal direction). Such a switch lever also realizes the operation member that can be easily depressed with one or more fingers of a user, whether in the normal orientation or in the reverse orientation.

The needle scaler 1B can be used in various attitudes. Specifically, the side on which the handle 3B is placed relative to the driving axis DX in the vertical direction, and the angle of the driving axis DX relative to a working surface of a workpiece can be changed according to the kind of machining and the position and angle of the working surface. In the needle scaler 1B of this embodiment, as described above, the orientation in which the grip part 31 is held does not substantially affect the operability of the trigger 35. Thus, the needle scaler 1B exhibits superior operability in various attitudes as described in the following non-limiting examples.

For example, in an operation of crushing a wall surface in front of a user, the user can hold the grip part 31 in the normal orientation, or hold the needle scaler 1B in an attitude (hereinafter referred to as a normal attitude) in which the handle 3B is placed below the driving axis DX in the vertical direction and protrudes downward (or obliquely downward). Alternatively, the user can hold the grip part 31 in the reverse orientation, or hold the needle scaler 1B in an attitude (hereinafter referred to as an inverted attitude) in which the handle 3B is placed above the driving axis DX in the vertical direction and protrudes upward (or obliquely upward).

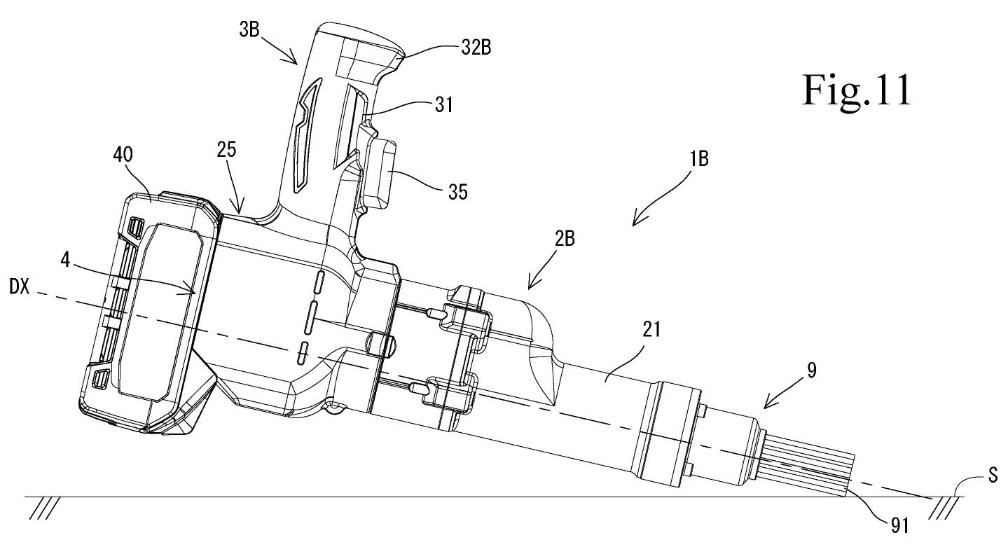

In an operation of removing foreign matters from a working surface, as shown in FIG. 11, it is preferable that an angle formed between a working surface S and the driving axis DX is made as small as possible. Accordingly, the user can easily perform the operation by holding the needle scaler 1B in the inverted attitude and holding the grip part 31 in the reverse orientation.

Further, in the needle scaler 1B of this embodiment, the battery mounting part 4 is arranged in the rear end part 25 of the tool body 2B such that the driving axis DX passes through the battery mounting part 4 and the battery 40. With this arrangement, compared with the needle scaler 1A of the first embodiment in which the battery 40 is mounted to the lower end of the handle 3A, the needle scaler 1B is improved in operability and/or workability when used in various attitudes, as described in the following.

Firstly, when using the needle scaler 1B while holding the grip part 31 in the reverse orientation, a user can obtain similar operability and sense of use to those obtained when using the needle scaler 1B while holding the grip part 31 in the normal orientation. Specifically, when the needle scaler 1A of the first embodiment is used in the inverted attitude, a relatively heavy battery 40 is located above the driving axis DX in the vertical direction, so that user’s operation is not easily performed with stability. The needle scaler 1B of this embodiment can however be stably operated even in the inverted attitude. In this embodiment, the grip part 31 extends in a direction substantially orthogonal to the driving axis DX. This arrangement also helps realize similar operability and sense of use in the reverse orientation to those in the normal orientation.

Secondly, when the needle scaler 1B is used in the attitude with the handle 3B protruding in a direction toward a working surface of the workpiece, the angle formed between the driving axis DX and the working surface of the workpiece can be made smaller than that of the needle scaler 1A of the first embodiment. Therefore, the attitude with the handle 3B protruding in a direction toward the surface of the workpiece can be applied to a greater variety of operations.

Thirdly, in the needle scaler 1B with the battery 40 mounted to the battery mounting part 4, in the front-rear direction, the motor 51 and the hammering mechanism 6 are arranged forward of the grip part 31, while the heavy battery 40 is arranged rearward of the grip part 31. With this arrangement, superior operability is realized when the needle scaler 1B is used in the attitude with the driving axis DX extending in a substantially horizontal direction.

The battery 40 has a rectangular parallelepiped shape, so that, among outer surfaces of the battery 40 mounted to the battery mounting part 4, the mounting surface 400 and the opposite surface 401 are substantially orthogonal to the driving axis DX (see FIG. 8). In this embodiment, the driving axis DX, the rotational axis RX1 of the motor 51 and the rotational axis RX2 of the intermediate shaft 60 all pass through the battery mounting part 4 (specifically, the rear wall part 251) and the surface 401 of the battery 40. Thus, the needle scaler 1B is stably supported when the surface 401 of the battery 40 mounted to the battery mounting part 4 is placed on a substantially horizontal plane (such as an upper surface of a workbench and a floor surface).

As for the other effects obtained by provision of substantially the same elements or structures as in the needle scaler 1A of the first embodiment, the needle scaler 1B also has the same effects as those described in the first embodiment.

### <Third Embodiment>

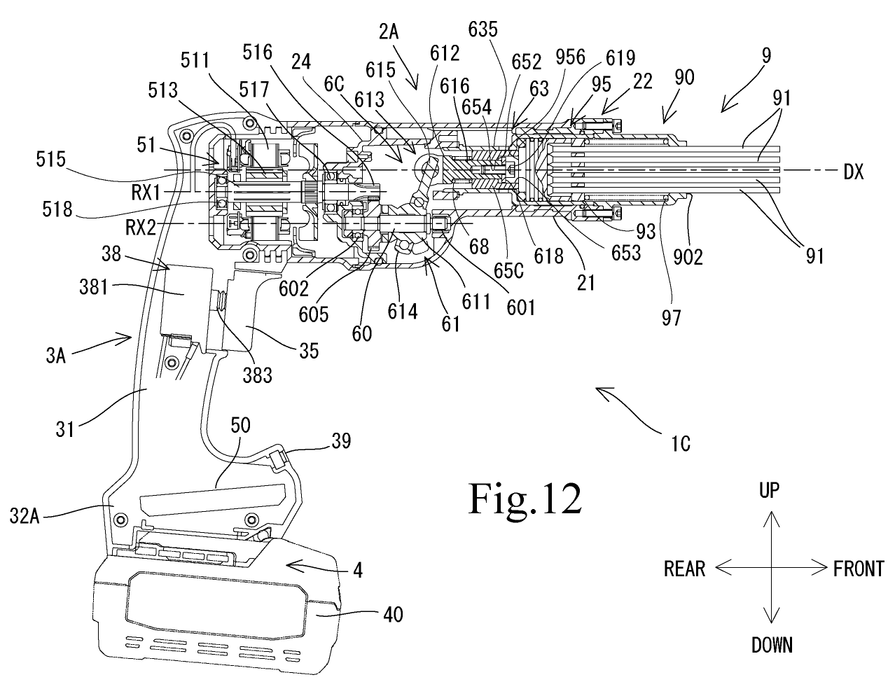

As shown in FIG. 12, a needle scaler 1C according to a third embodiment of the present disclosure is different from the needle scaler 1A of the first embodiment in that a hammering mechanism 6C is provided in place of the hammering mechanism 6, but otherwise it has substantially the same structure as the first embodiment. In the needle scaler 1C, like in the needle scaler 1A of the first embodiment, the battery mounting part 4 to which the battery 40 as a power source can be mounted is provided in the lower end part 32A of the handle 3A.

As shown in FIG. 12, the hammering mechanism 6C is of a so-called mechanical spring type that applies hammering force to the needles 91 by utilizing a mechanical spring. The other structure of the hammering mechanism 6C is substantially the same as the hammering mechanism 6.

The hammering mechanism 6C is configured to convert rotational power of the motor 51 into linear motion and apply axial hammering force to the scaling mechanism 9 by utilizing an elastic force of an elastic element and thus move the needles 91 in the axial direction. The hammering mechanism 6C has a rod 616, a compression coil spring 68 and a striker 65C.

The rod 616 is a metal member having a columnar shape such as a cylinder and a polygonal column. The rod 616 is disposed within the small-diameter part 635 of the cylinder 63. The rod 616 is reciprocated in the front-rear direction within the small-diameter part 635 along with oscillation of the arm part 615. A spring receiver 612 is formed on a rear end of the rod 616 and protrudes radially outward. A bolt 619 is fastened to the center of a front end of the rod 616, and a washer 618 is fixed on the front end of the rod 616 by the bolt 619.

The striker 65C is a striking element that is configured to apply hammering force to the needles 91 by striking the anvil 95 of the scaling mechanism 9 along with reciprocation of the rod 616. The striker 65C is different in shape from the striker 65 of the first embodiment, but otherwise it has substantially the same structure.

The striker 65C has a generally cylindrical shape having a stepped through hole 654 inside. The striker 65C is arranged within the small-diameter part 635 of the cylinder 63 so as to be slidable along the driving axis DX. Thus, the small-diameter part 635 of the cylinder 63 is configured as a sliding guide for the striker 65C.

A recess 653 having a circular section is formed in a central part of a front end surface of the striker 65C. The striker 65C is arranged with the open side facing forward and configured to slide on the radial outside of the rod 616. The recess 653 in the front end part of the striker 65C has a bottom 652 having a smaller diameter than a front end of the recess 653. The rod 616 is inserted into the through hole 654 formed through the bottom 652, and the striker 65C is configured to slide on the radial outside of the rod 616 in the front-rear direction relative to the rod 616.

The washer 618 has a larger outer diameter than the outer diameter of the front end of the rod 616. When the striker 65C moves forward, the washer 618 abuts on the bottom 652 of the striker 65C and thus restricts further forward movement of the striker 65C. In the position where the washer 618 restricts movement of the striker 65C, the washer 618 and the bolt 619 are received in the recess 653 of the striker 65C, and the front end of the striker 65C is located forward of the washer 618 and the front end of the bolt 619.

The compression coil spring 68 is inserted onto the rod 616 and arranged on the radial outside of the rod 616. The compression coil spring 68 elastically connects the rod 616 and the striker 65C. Specifically, the rear side of the compression coil spring 68 is supported by the spring receiver 612 of the rod 616 and biases the striker 65C forward. The hammering mechanism 6C may have an arbitrary elastic element such as a plate spring and a disc spring in place of the compression coil spring 68. Further, the hammering mechanism 6C may have a spring that is not limited to a metal spring, but is formed of an arbitrary elastic material, including an elastomer and a polymeric material, such as urethane rubber.

The hammering mechanism 6C is operated by driving of the motor 51 and applies hammering force to the scaling mechanism 9. The striker 65C receives the elastic force of the compression coil spring 68 along with reciprocation of the rod 616 and slides in the front-rear direction within the cylinder 63. More specifically, when the rod 616 is moved forward, the compression coil spring 68 is compressed and the striker 65C moves forward by the biasing force of the compression coil spring 68. The front end of the striker 65C then collides with the rear surface of the rear small-diameter part 956 of the anvil 95 and applies hammering force to the needles 91. The compression coil spring 68 elastically absorbs the impact of the collision between the striker 65C and the anvil 95.

As described above, the needle scaler 1C of this embodiment has the mechanical-spring type hammering mechanism 6C. The hammering mechanism 6C reciprocates the striker 65C by the elastic force of the compression coil spring 68 that is generated by reciprocation of the rod 616 and applies hammering force to the needles 91 of the scaling mechanism 9. Thus, the hammering mechanism 6C is realized with a relatively simple structure and the needle scaler 1C is improved in productivity. Further, the hammering force of the striker 65C can be adjusted by a simple way of adjusting the elastic force of the compression coil spring 68.

The needle scaler 1C of this embodiment has the battery mounting part 4 to which the battery 40 can be mounted. Therefore, the mechanical-spring type needle scaler 1C is provided with excellent operability and portability, compared with a mechanical-spring type needle scaler 1C that can be connected to an external commercial power source.

### <Fourth Embodiment>

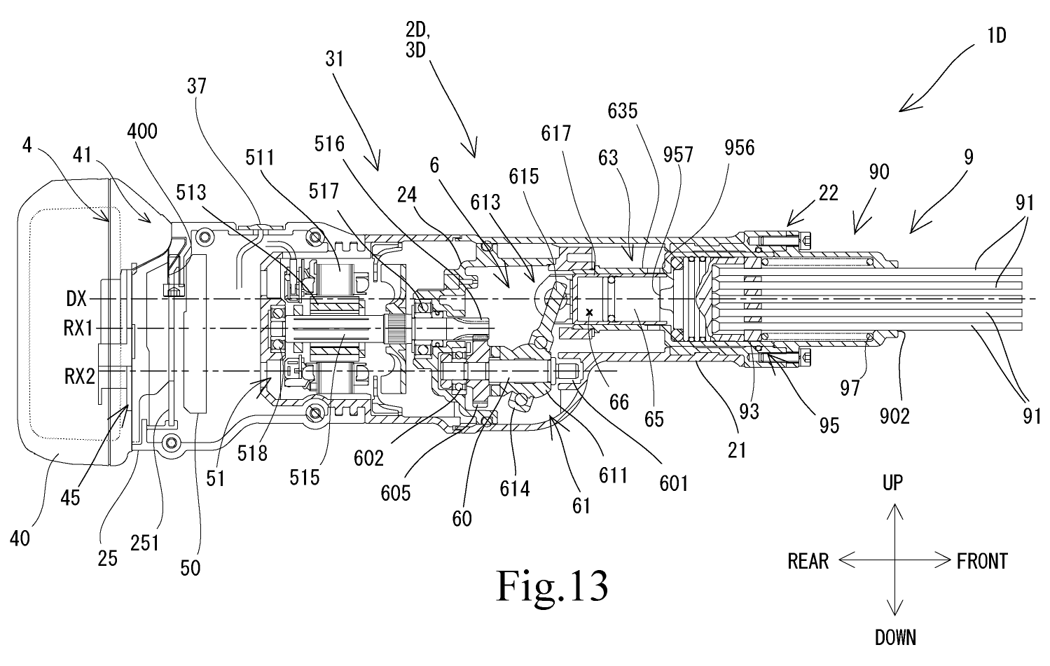

As shown in FIG. 13, a needle scaler 1D according to a fourth embodiment of the present disclosure is different from the needle scaler 1A of the first embodiment in that a tool body 2D and a handle 3D are provided in place of the tool body 2A and the handle 3A, respectively, and in that a touch switch 37 is provided in place of the trigger 35 and the switch 38, but otherwise it has substantially the same structure as the needle scaler 1A.

As shown in FIG. 13, the needle scaler 1D of this embodiment has the tool body 2D extending along the driving axis DX. The tool body 2D houses the motor 51, the hammering mechanism 6 and the scaling mechanism 9 that are arranged in the axial direction. In this embodiment, the tool body 2D also serves as the handle 3D. Thus, the needle scaler 1D has a so-called straight type handle 3D. Specifically, a rear part of the tool body 2D that extends rearward of the barrel part 21 serves as the grip part 31. Thus, the longitudinal direction of the handle 3D is substantially parallel to the driving axis DX. For example, a user can hold a rear half part of the tool body 2D with one hand and auxiliary hold the barrel part 21 with the other hand. By integrating the handle 3D with the tool body 2D, the needle scaler 1D is reduced in size in the up-down direction, so that the needle scaler 1D is improved in portability and in workability in a narrow place.

As shown in FIG. 13, the touch switch 37, for example, of a capacitance type is provided on an upper end part of the handle 3D. The touch switch 37 receives a touch operation of the user and outputs an ON signal to the controller 50. The touch switch 37 is also referred to as a touch sensor and a touch key. When receiving the ON signal, the controller 50 supplies electric power to the motor 51 and drives the motor 51. When the touch switch 37 is not operated, the touch switch 37 stops outputting the ON signal to the controller 50, and the motor 51 stops. The arrangement position of the touch switch 37 is not limited to the upper side of the tool body 2D, but the touch switch 37 may be arranged in an arbitrary position such as on the left or right side or the lower side of the tool body 2D.

In place of the touch switch 37, however, the needle scaler 1D may have a push switch that receives a pushing-down operation of the user and outputs an ON signal to the controller 50, or a push-down type mechanical switch such as a tactile switch. Alternatively, in place of the touch switch 37, the needle scaler 1D may have various kinds of operation parts such as a slide switch or a switch lever that is turned on and off by sliding operation in one direction, and a trigger switch or a paddle switch that is turned on and off by depressing operation.

As shown in FIG. 13, the battery 40 and the battery mounting part 4 have substantially the same structures as in the second embodiment. Specifically, the battery mounting part 4 is provided in the rear end part 25 of the tool body 2D. The direction of mounting the battery 40 to the battery mounting part 4 substantially corresponds to the downward direction of the needle scaler 1D. When the battery 40 is mounted to the battery mounting part 4, the rear wall part 251 of the tool body 2D faces the mounting surface 400 of the battery 40.

In this embodiment, the driving axis DX passes through the battery mounting part 4 (specifically, the rear wall part 251) and the battery 40. Thus, the driving axis DX passes through the battery mounting part 4 (specifically, the rear wall part 251) and the battery 40, when the needle scaler 1D is viewed from the left-right direction. Further, the driving axis DX also passes through the battery mounting part 4 and the battery 40, when the needle scaler 1D is viewed from the up-down direction. The driving axis DX passes through the centers of the battery mounting part 4 and the battery 40 in the left-right direction.

The direction of mounting the battery 40 to the battery mounting part 4 may substantially correspond to the front-rear direction of the needle scaler 1D. For example, the guide grooves 42 may extend in the front-rear direction in parallel to the driving axis DX. With this structure, the needle scaler 1D is reduced in size in the up-down direction. In this case, the driving axis DX may or may not pass through the battery mounting part 4 and the battery 40.

As shown in FIG. 13, the arrangement of the controller 50 within the tool body 2D is the same as in the second embodiment. Thus, the controller 50 is arranged within the rear end part 25 of the tool body 2D and extends in the up-down direction. More specifically, the controller 50 is arranged between the motor 51 and the battery mounting part 4 in the front-rear direction. The driving axis DX passes through the motor 51 and the controller 50 as well as through the battery mounting part 4. It can also be said that the controller 50 is arranged within a rear end part of the handle 3D extending in the front-rear direction.

The controller 50 may however be arranged to extend in the front-rear direction within the tool body 2D. For example, where the guide grooves 42 of the battery mounting part 4 extend in the front-rear direction in parallel to the driving axis DX, the controller 50 and the battery mounting part 4 can be rationally arranged in the tool body 2D by arranging the controller 50 in parallel to the battery mounting part 4.

### <Fifth Embodiment>

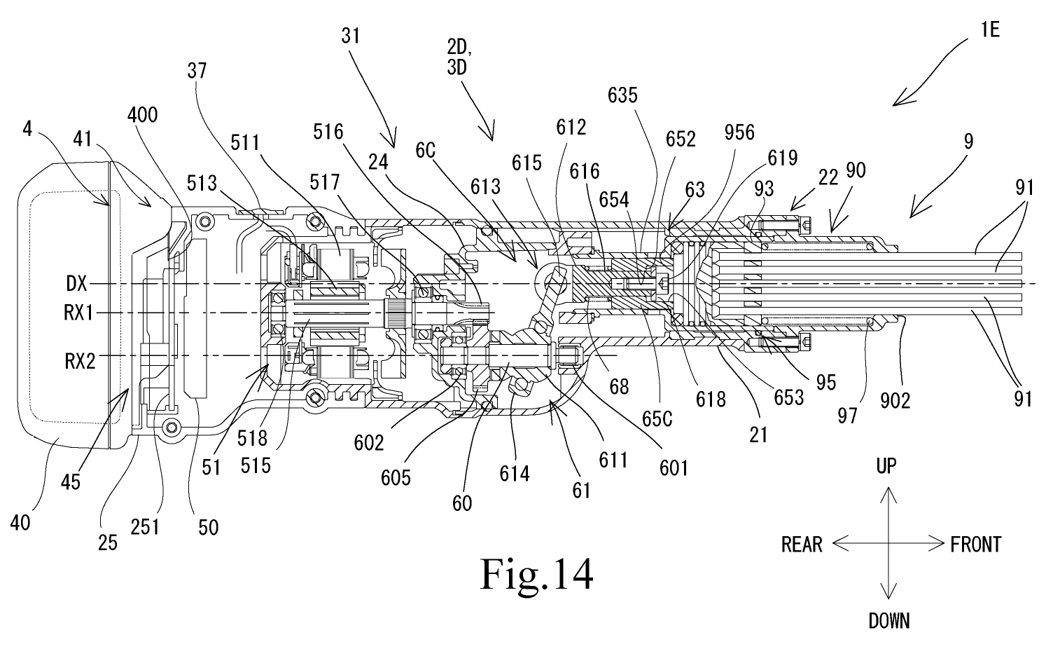

As shown in FIG. 14, a needle scaler 1E according to a fifth embodiment of the present disclosure is a modification of the needle scaler 1D of the fourth embodiment. The needle scaler 1E is different from the needle scaler 1D of the fourth embodiment in the structure of the hammering mechanism 6C, but otherwise it has substantially the same structure as the needle scaler 1D of the fourth embodiment. The hammering mechanism 6C is of a so-called mechanical spring type described in the third embodiment above. Thus, as shown in FIG. 14, the needle scaler 1E may be provided with a combination of the straight type handle 3D integrally formed with the tool body 2D and the mechanical spring type hammering mechanism 6C.

### <Sixth Embodiment>

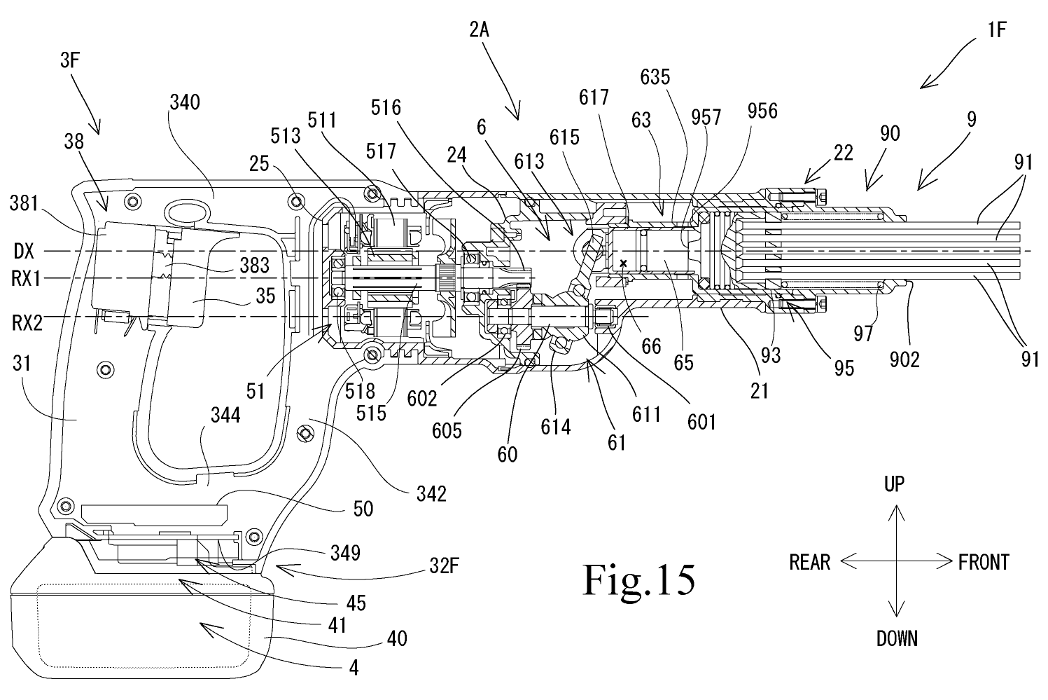

As shown in FIG. 15, a needle scaler 1F according to a sixth embodiment of the present disclosure is different from the needle scaler 1A of the first embodiment in that a handle 3F is provided in place of the handle 3A, but otherwise it has substantially the same structure as the first embodiment.

The handle 3F is connected to the rear end part 25 of the tool body 2A. The handle 3F is annularly formed, having a generally D-shape when the needle scaler 1F is viewed from the left-right direction. The handle 3F is also referred to as a D-shaped handle. The handle 3F includes a grip part 31, an upper extending part 340, a front extending part 342 and a lower extending part 344.

The grip part 31 extends in the up-down direction. A trigger 35 having the same structure as the trigger 35 of the first embodiment is provided on the front side of the upper end part of the grip part 31. The arrangement of the trigger 35 is different from that of the first embodiment. Specifically, in this embodiment, the trigger 35 is arranged in a position where the driving axis DX passes through the grip part 31 and the trigger 35 when the needle scaler 1F is viewed from the left-right direction. Further, the driving axis DX also passes through the grip part 31 and the trigger 35 when the needle scaler 1F is viewed from the up-down direction. With this arrangement, a user can easily perform the operation of pressing the needles 91 onto a workpiece in the axial direction (the front-rear direction) corresponding to the extending direction of the driving axis DX, while holding the handle 3F and operating the trigger 35.

The upper extending part 340 extends rearward from the upper side of the rear end part 25 of the tool body 2A and is connected to the upper end part of the grip part 31. The lower extending part 344 extends forward from the lower end part of the grip part 31.

The controller 50 is housed in the lower extending part 344 and extends in the front-rear direction. The arrangement and structure of the controller 50 is substantially the same as the controller 50 of the first embodiment. Specifically, the controller 50 is arranged in a position where a line orthogonal to the driving axis DX passes through the controller 50 and the grip part 31 when the needle scaler 1F is viewed from the left-right direction. The controller 50 may be arranged other than in the lower extending part 344 and may be arranged to extend in the up-down direction.

The battery mounting part 4 is provided extending in the front-rear direction in a lower end part of the lower extending part 344, or a lower end part 32F of the handle 3F. The arrangement and structure of the battery mounting part 4 is substantially the same as the battery mounting part 4 of the first embodiment. Specifically, the battery mounting part 4 is arranged in a position where a line orthogonal to the driving axis DX passes through the battery mounting part 4 and the handle 3F when the needle scaler 1F is viewed from the left-right direction. The battery mounting part 4 may be arranged other than in the lower end part 32F of the handle 3F such as on a rear end of the grip part 31 and may be arranged to extend in the up-down direction.

As shown in FIG. 15, the front extending part 342 connects the lower extending part 344 and the rear end part 25 of the tool body 2A. More specifically, the front extending part 342 extends substantially upward from a front end part of the lower extending part 344 and is connected to the lower side of the rear end part 25 of the tool body 2A.

In the needle scaler 1F of this embodiment, the handle 3F is formed in an annular form, which improves the strength of the handle 3F, compared, for example, with a cantilever handle like the handle 3A of the first embodiment. Further, when operating the needle scaler 1F in the inverted attitude, a user can improve the workability in the operation in the inverted attitude by holding the grip part 31 with one hand and auxiliary holding the front extending part 342 with the other hand. In the operation in the inverted attitude, by auxiliary holding the front extending part 342, the user can more easily place an upper end of the tool body 2A close to a working surface than when holding the barrel part 21 and thus improve the workability in the operation in the inverted attitude.

### <Seventh Embodiment>

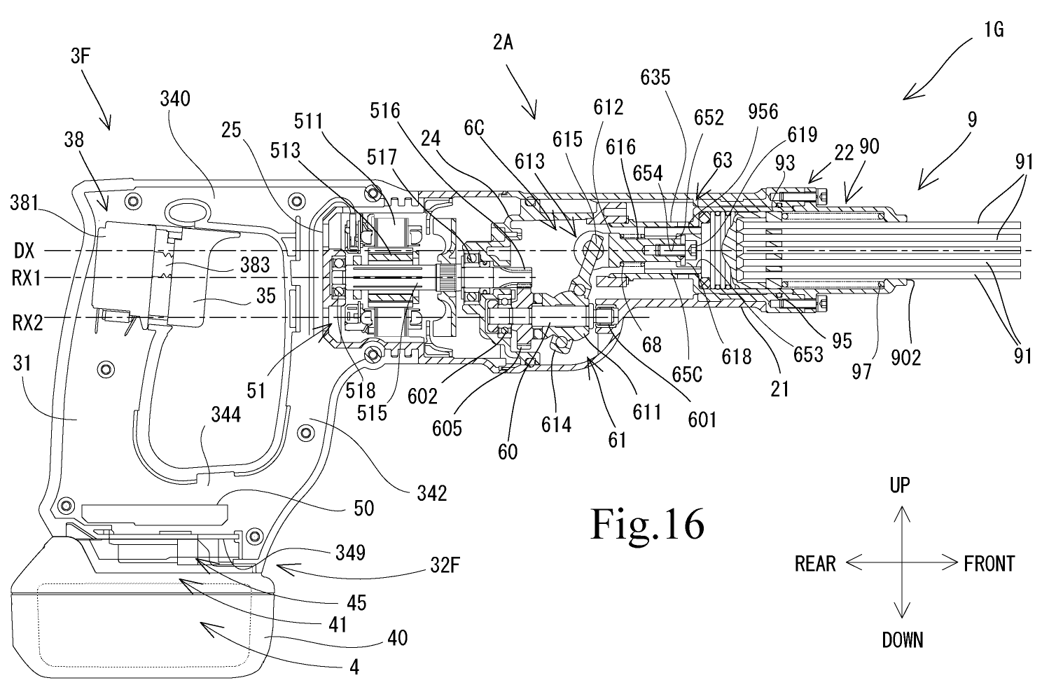

As shown in FIG. 16, a needle scaler 1G according to a seventh embodiment of the present disclosure is a modification of the needle scaler 1F of the sixth embodiment. The needle scaler 1G is different from the needle scaler 1F of the sixth embodiment in the structure of the hammering mechanism 6C, but otherwise it has substantially the same structure as the needle scaler 1F of the sixth embodiment. The hammering mechanism 6C is of a so-called mechanical spring type described in the third embodiment above. Thus, as shown in FIG. 16, the needle scaler 1G may be provided with a combination of the so-called D-shaped handle 3F connected to the rear end part 25 of the tool body 2A and the mechanical spring type hammering mechanism 6C.

### <Eighth Embodiment>

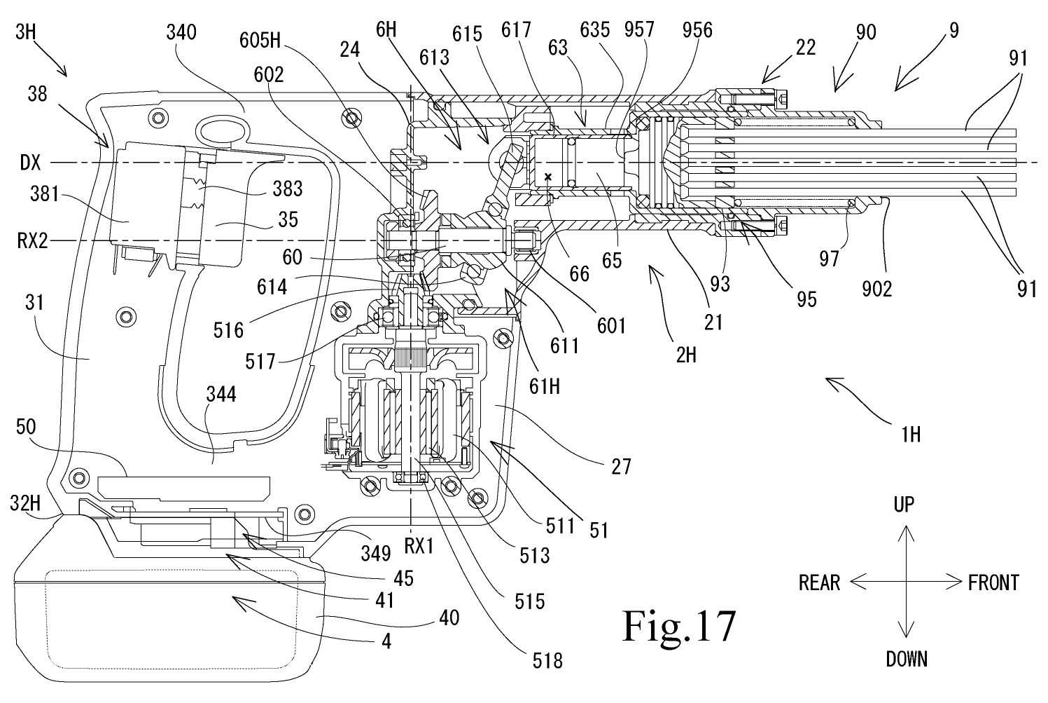

As shown in FIG. 17, a needle scaler 1H according to an eighth embodiment of the present disclosure is different from the needle scaler 1A of the first embodiment in that a handle 3H, a tool body 2H and a hammering mechanism 6H are provided in place of the handle 3A, the tool body 2A and the hammering mechanism 6, respectively, but otherwise it has substantially the same structure as the needle scaler 1A of the first embodiment.

The tool body 2A of the first embodiment extends along the driving axis DX, but the tool body 2H is generally L-shaped. Specifically, the tool body 2H has a barrel part 21 and a body extending part 27. The barrel part 21 has substantially the same structure as the barrel part 21 of the first embodiment and is a hollow body extending along the driving axis DX. The barrel part 21 houses part of the scaling mechanism 9 and part of the hammering mechanism 6H.

The body extending part 27 is connected to a rear end of the barrel part 21. The body extending part 27 extends substantially downward from the rear end of the barrel part 21. The body extending part 27 houses the motor 51 and part of the hammering mechanism 6H. The motor 51 is arranged just below a motion convert converting mechanism 61H. Specifically, the motor 51 is arranged below the driving axis DX and the rotational axis RX2 when the needle scaler 1H is viewed from the left-right direction. With this arrangement of the motor 51 below the driving axis DX and the rotational axis RX2, the needle scaler 1H is reduced in length in the front-rear direction. In this embodiment, the rotational axis RX1 of the output shaft 515 of the motor 51 extends in the up-down direction orthogonally to the driving axis DX and the rotational axis RX2.

The hammering mechanism 6H is different from the hammering mechanism 6 of the first embodiment in that the motion convert converting mechanism 61H has a gear 605H in place of the gear 605, but otherwise it has substantially the same structure as the hammering mechanism 6 of the first embodiment. The gear 605H is arranged with gear teeth facing rearward and engaged with the pinion 516 formed on the extending end of the output shaft 515 extending in the up-down direction. Thus, the hammering mechanism 6H is configured to convert rotational power of the rotational axis RX1 of the output shaft 515 extending in the up-down direction into linear motion in the front-rear direction and apply hammering force to the scaling mechanism 9.

The rotational axis RX1 of the output shaft 515 of the motor 51 may cross not orthogonally but obliquely at a prescribed angle to the driving axis DX and the rotational axis RX2. For example, the arrangement of the motor 51 is changed such that an upper end part of the motor 51 (an upper end of the output shaft 515) is located at substantially the same position as that shown in FIG. 17 and a lower end part of the motor 51 is located forward of the position shown in FIG. 17. In this case, the rotational axis RX1 is inclined forward toward the lower side. With this structure, the lower end part of the motor 51 is shifted forward, so that the handle 3H can be shifted forward toward the tool body 2H. Therefore, the needle scaler 1H is reduced in length in the front-rear direction and thus reduced in size. In this case, it is preferable that the angle of the gear teeth of the gear 605H is changed to correspond to the pinion 516 of the inclined output shaft 515.

The handle 3H connects the grip part 31 and the tool body 2H and forms an annular part together with the grip part 31 and the tool body 2H. The handle 3H includes the grip part 31, an upper extending part 340 and a lower extending part 344.

The grip part 31 extends in the up-down direction. A trigger 35 having the same structure as the trigger 35 of the sixth embodiment is provided on the front side of the upper end part of the grip part 31. Specifically, in this embodiment, the trigger 35 is arranged in a position where the driving axis DX passes through the grip part 31 and the trigger 35 when the needle scaler 1H is viewed from the left-right direction. Further, the driving axis DX also passes through the grip part 31 and the trigger 35 when the needle scaler 1H is viewed from the up-down direction. With this arrangement, a user can easily perform the operation of pressing the needles 91 onto a workpiece in the axial direction (the front-rear direction) corresponding to the extending direction of the driving axis DX, while holding the handle 3H and operating the trigger 35.

The upper extending part 340 extends rearward from an upper rear end of the tool body 2H or the rear end of the barrel part 21, and is connected to the upper end part of the grip part 31. The lower extending part 344 extends forward from the lower end part of the grip part 31 and is connected to the body extending part 27.

The controller 50 is housed in the lower extending part 344 and extends in the front-rear direction. The arrangement and structure of the controller 50 is substantially the same as the controller 50 of the first embodiment. Specifically, the controller 50 is arranged in a position where a line orthogonal to the driving axis DX passes through the controller 50 and the grip part 31 when the needle scaler 1H is viewed from the left-right direction. The controller 50 may be arranged other than in the lower extending part 344 and may be arranged to extend in the up-down direction.

The battery mounting part 4 is provided extending in the front-rear direction in a lower end part of the lower extending part 344, or a lower end part 32H of the handle 3H. The arrangement and structure of the battery mounting part 4 is substantially the same as the battery mounting part 4 of the first embodiment. Specifically, the battery mounting part 4 is arranged in a position where a line orthogonal to the driving axis DX passes through the battery mounting part 4 and the handle 3H when the needle scaler 1H is viewed from the left-right direction. The controller 50 may be arranged other than in the lower end part 32H of the handle 3H such as on the rear end of the grip part 31 and may be arranged to extend in the up-down direction.

In the needle scaler 1H of this embodiment, by arranging the motor 51 below the driving axis DX and the rotational axis RX2, the length of the needle scaler 1H in the front-rear direction is reduced and thus the workability of the needle scaler 1H is improved. Further, by forming the handle 3H in an annular form, the handle 3H is improved in strength, compared, for example, with a cantilever handle like the handle 3A of the first embodiment. Further, when operating the needle scaler 1H in the inverted attitude, a user can improve the workability in the operation in the inverted attitude by holding the grip part 31 with one hand and auxiliary holding the body extending part 27 with the other hand. In the operation in the inverted attitude, by auxiliary holding the body extending part 27 , the user can more easily place an upper end of the tool body 2H close to a working surface than when holding the barrel part 21 and thus improve the workability in the operation in the inverted attitude.

### <Ninth Embodiment>

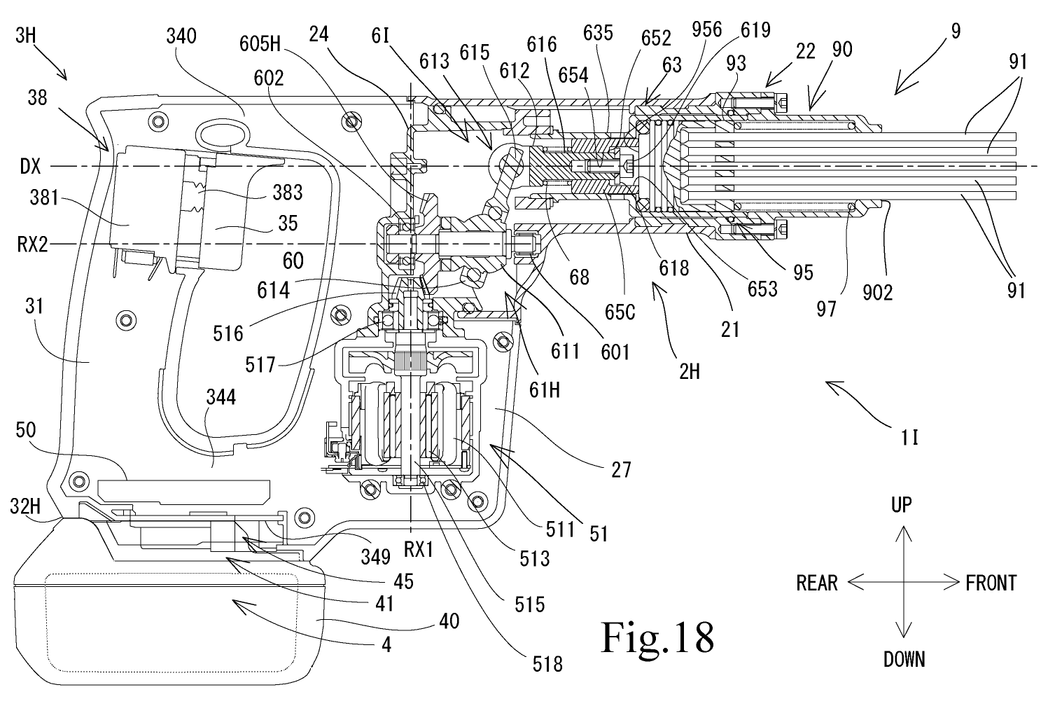

As shown in FIG. 18, a needle scaler 1I according to a ninth embodiment of the present disclosure is a modification of the needle scaler 1H of the eighth embodiment. The needle scaler 1I is different from the needle scaler 1H of the eighth embodiment in the structure of a hammering mechanism 6I, but otherwise it has substantially the same structure as the needle scaler 1H of the eighth embodiment. The hammering mechanism 6I has the motion convert converting mechanism 61H including the gear 605H of the eighth embodiment, in place of the motion convert converting mechanism 61 of the hammering mechanism 6C of the third embodiment. Specifically, the needle scaler 1I may be provided with a combination of the handle 3H, the tool body 2H and the mechanical spring type hammering mechanism 6I.

### <Tenth Embodiment>

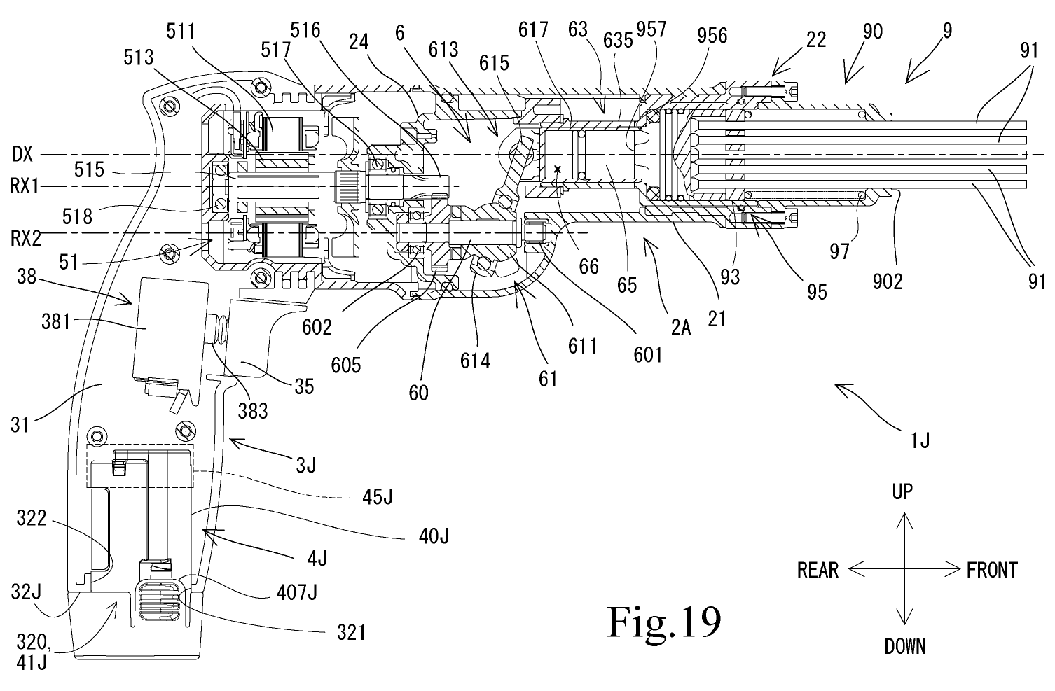

As shown in FIG. 19, a needle scaler 1J according to a tenth embodiment of the present disclosure is different from the needle scaler 1A of the first embodiment in that a handle 3J and a battery mounting part 4J are provided in place of the handle 3A and the battery mounting part 4, respectively, but otherwise it has substantially the same structure as the first embodiment. The needle scaler 1J is configured such that a battery 40J that is different from the battery 40 of the first embodiment and is also referred to as a so-called stick type battery can be mounted thereto.

Unlike the battery 40 having a generally rectangular parallelepiped shape in the first embodiment, the battery 40J has a rod-like shape extending in one direction. The battery 40J has a smaller battery capacity (Ah) than the battery 40. The battery 40J has a smaller size than the battery 40 and is configured such that most of the battery 40J can be inserted into the handle 3J. The battery 40J has a locking member 407J.

The handle 3J is similar to the handle 3A of the first embodiment in that it is a so-called pistol grip and is connected to the tool body 2A in a cantilever manner. The handle 3J is different from the handle 3A of the first embodiment in that it has a lower end part 32J different in shape from the lower end part 32A and in that the handle 3J has the battery mounting part 4J in place of the battery mounting part 4.

The lower end part 32J of the handle 3J is a free end and has substantially the same outer diameter as the outer diameter of the grip part 31. A battery insertion part 320 is formed in the lower end part 32J. The battery insertion part 320 is configured to receive part of the battery 40J. The battery insertion part 320 includes an opening 321 formed in the lower end part 32J of the handle 3J, and a guide wall 322 connected to the opening 321 and extending into the inside of the handle 3J. The battery 40J is inserted from the opening 321 and the guide wall 322 defines the inserting direction of the battery 40J. An engagement part (not shown) is formed on the battery insertion part 320 and configured to be engaged with the locking member 407J of the battery 40J.

The battery mounting part 4J includes an engagement part 41J that can be physically engaged with the battery 40J, and a connector part 45J that can be electrically connected to the battery 40J. The engagement part 41J includes the battery insertion part 320 formed in the lower end part 32J of the handle 3J.

The connector part 45J is arranged in the inside of the handle 3J. In this embodiment, the connector part 45J is arranged just below the switch 38. The connector part 45J includes terminals that can be electrically connected to terminals of the battery 40J.

When the battery 40J is mounted to the battery mounting part 4J, the battery 40J is inserted into the opening 321 of the battery insertion part 320 from below the handle 3J. Thus, in this embodiment, the direction of mounting the battery 40J to the battery mounting part 4J substantially corresponds to the upward direction of the needle scaler 1J. When the battery 40J is guided by the guide wall 322 and moved upward to a prescribed mounting position, the locking member 407J is engaged with the engagement part of the battery insertion part 320, so that the battery 40J is restricted from moving relative to the battery mounting part 4J in the up-down direction. The connector part 405 (terminals) of the battery 40J is then electrically connected to the connector part 45J (terminals) and mounting of the battery 40J is completed. The mounted battery 40J extends in the up-down direction of the needle scaler 1J. The mounted battery 40J can be removed from the battery mounting part 4J by manually operating the locking member 407J to disengage the locking member 407J from the engagement part (not shown).

As described above, the needle scaler 1J of this embodiment is configured such that the stick type battery 40J can be removably mounted thereto. Therefore, the needle scaler 1J is reduced in weight and size, compared with the needle scaler 1A of the first embodiment, so that the needle scaler 1J is improved in operability and portability.

### <Eleventh Embodiment>

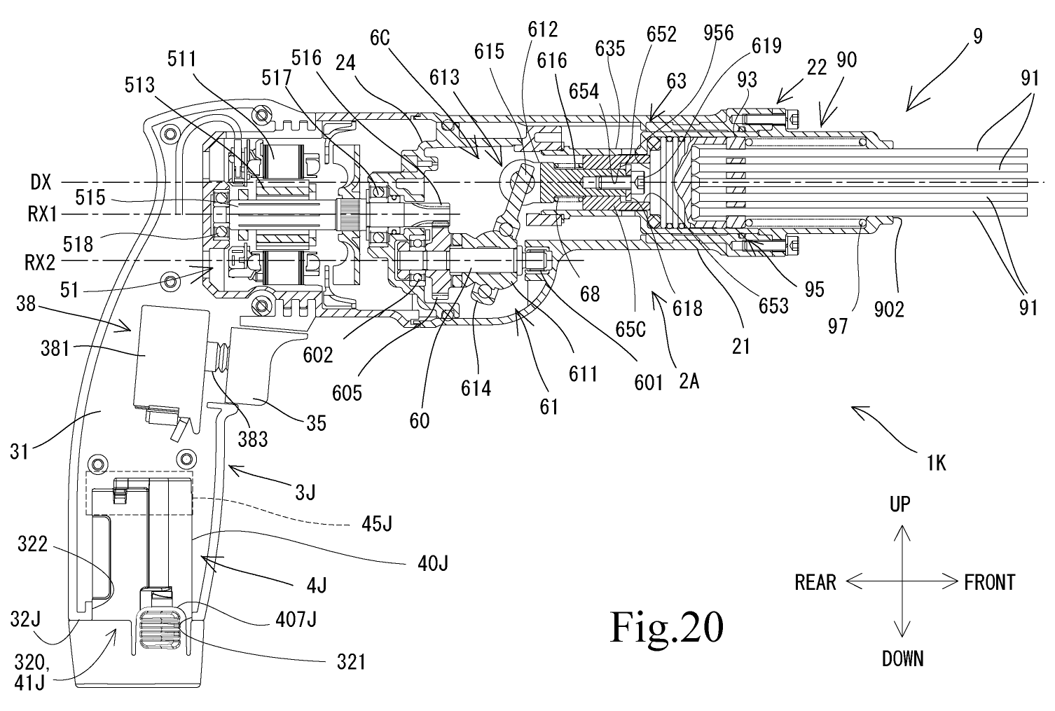

As shown in FIG. 20, a needle scaler 1K according to an eleventh embodiment of the present disclosure is a modification of the needle scaler 1J of the tenth embodiment. The needle scaler 1K is different from the needle scaler 1J of the tenth embodiment in that a hammering mechanism 6C is provided in place of the hammering mechanism 6, but otherwise it has substantially the same structure as the needle scaler 1J of the tenth embodiment. The hammering mechanism 6C is of a so-called mechanical spring type described in the third embodiment. Thus, as shown in FIG. 20, the needle scaler 1K may be provided with a combination of the handle 3J and the battery mounting part 4J to which the stick type battery 40J can be removably mounted, and the mechanical spring type hammering mechanism 6C. The needle scalers of the third to ninth embodiments may be configured such that the stick type battery 40J can be removably mounted thereto, and the battery mounting part 4J of this embodiment may be provided in place of the battery mounting part 4.

### <Twelfth Embodiment>

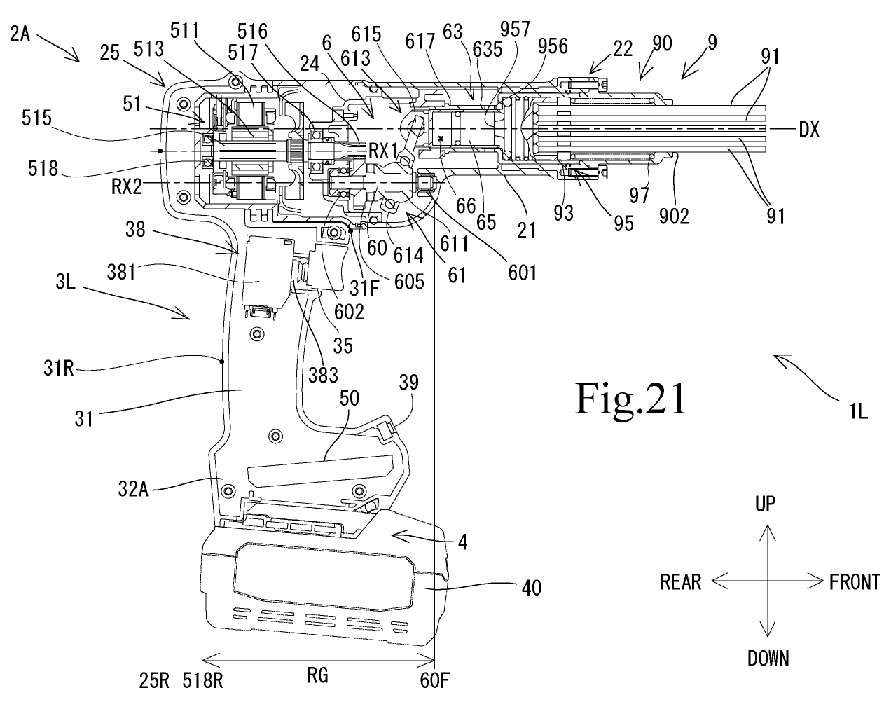

As shown in FIG. 21, a needle scaler 1L according to a twelfth embodiment of the present disclosure is different from the needle scaler 1A of the first embodiment in that a handle 3L is provided in place of the handle 3A, but otherwise it has substantially the same structure as the first embodiment.

The handle 3L is similar to the handle 3A of the first embodiment in that it is connected to the tool body 2A in a cantilever manner, but different in the arrangement relative to the tool body 2A. In the other points, the handle 3L has substantially the same structure as the handle 3A.

As shown in FIG. 21, in this embodiment, the handle 3L is arranged forward of a connecting position (shown in FIG. 3) between the tool body 2A and the handle 3A. The handle 3L and the tool body 2A form a generally T-shape, so that the handle 3L is also referred to as a T-shaped handle.

The motor 51 and the motion convert converting mechanism 61 are arranged in a rear part of the tool body 2A. In the needle scaler 1L, among the elements disposed in the tool body 2A, the loads on the motor 51 and the motion convert converting mechanism 61 tend to be large compared with the loads on the other elements. Thus, the center of gravity of the needle scaler 1L is located slightly rearward of the center of the tool body 2A in the extending direction of the driving axis DX.

As shown in FIG. 21, the handle 3L is connected to the tool body 2A at a position slightly rearward of the center of the tool body 2A so as to be connected at a position close to the center of gravity of the needle scaler 1L. Specifically, a base end of the handle 3L is connected to the tool body 2A within a range RG from an arrangement position 518R of the rear bearing 518 of the motor 51 to an arrangement position 60F of the front bearing 601 of the intermediate shaft 60 of the motion convert converting mechanism 61 in the front-rear direction. Therefore, the needle scaler 1L can be operated in a well-balanced manner by using the handle 3L. In other embodiments, the handle 3L may be connected within a range from the rear end 25R of the tool body 2A to the position 60F.

In this embodiment, the grip part 31 of the handle 3L is connected to the tool body 2A just below the motor 51 and extends in a direction substantially orthogonal to the driving axis DX. Further, the whole grip part 31 is arranged within the range RG. In other words, a rear end 31R of the grip part 31 is arranged forward of the position 518R, and a front end 31F of the grip part 31 is arranged rearward of the position 60F. Therefore, the needle scaler 1L can be operated in a well-balanced manner by using the handle 3L. The “front end 31F of the grip part 31” can include a front end of a member such as the trigger 35 that is provided in the grip part 31. The front end 31F of the grip part 31 may be a front end within a range from the trigger 35 to the lower end part 32A in the grip part 31. As shown in FIG. 21, in other embodiments, the rear end 31R of the grip part 31 may be arranged forward of the rear end 25R of the tool body 2A.

In the needle scaler 1L of this embodiment, the grip part 31 of the handle 3L is connected to the tool body 2A just below the motor 51 and extends in a direction substantially orthogonal to the driving axis DX. The handle 3L is connected to the tool body 2A at a position close to the center of gravity of the tool body 2A, so that the needle scaler 1L is easily well-balanced in the front-rear direction. Thus, the needle scaler 1L is improved in workability.

Further, by arranging the grip part 31 just below the tool body 2A, the whole length of the needle scaler 1L in the front-rear direction is shortened compared with the needle scaler 1A of the first embodiment. Therefore, the needle scaler 1L is reduced in size and thus improved in convenience.

### <Thirteenth Embodiment>

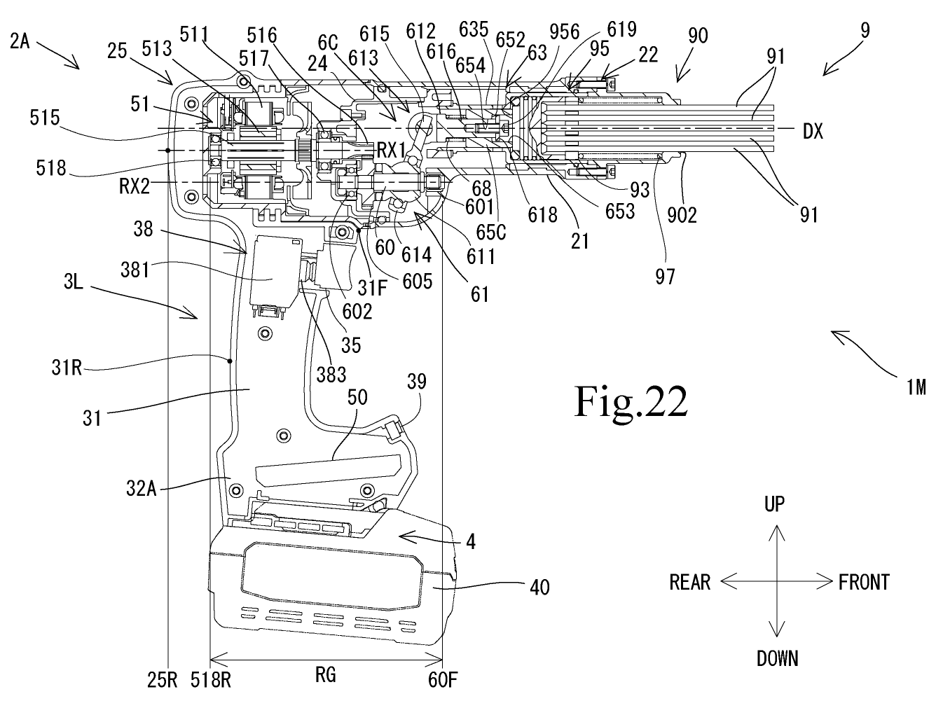

As shown in FIG. 22, a needle scaler 1M according to a thirteenth embodiment of the present disclosure is a modification of the needle scaler 1L of the twelfth embodiment. The needle scaler 1M is different from the needle scaler 1L of the twelfth embodiment in that a hammering mechanism 6C is provided in place of the hammering mechanism 6, but otherwise it has substantially the same structure as the needle scaler 1L. The hammering mechanism 6C is of a so-called mechanical spring type described in the third embodiment above. Thus, as shown in FIG. 22, the needle scaler 1M may be provided with a combination of the handle 3L, which is connected to the tool body 2A just below the motor 51 and extends in a direction substantially orthogonal to the driving axis DX, and the mechanical spring type hammering mechanism 6C.

As shown in FIG. 22, the base end of the handle 3L is connected to the tool body 2A within the range RG. The handle 3L may be connected within a range from the rear end 25R of the tool body 2A to the position 60F of the front end of the intermediate shaft 60, or within a range from the position 518R to the position 60F. The rear end 31R of the grip part 31 is arranged forward of the position 518R, and the front end 31F of the grip part 31 is arranged rearward of the position 60F.

Correspondences between the features of the above-described embodiments and the features of the present disclosure or invention are as follows. However, the features of the above-described embodiments are merely exemplary and do not limit the features of the present disclosure or invention.

The needle scalers 1A, 1B, 1C, 1D, 1E, 1F, 1G, 1H, 1I, 1J, 1K, 1L, 1M are examples of the “needle scaler”. The tool body 2A, 2B, 2D, 2H are examples of the “tool body”. The motor 51 is an example of the “motor”. The hammering mechanisms 6, 6C, 6H, 6I are examples of the “power transmitting mechanism” and the “hammering mechanism”. The scaling mechanism 9 and the needles 91 are examples of the “scaling mechanism” and the “needles”, respectively. The piston cylinder 617 and the strikers 65, 65C are examples of the “piston” and the “striker”, respectively. The piston cylinder 617, the strikers 65, 65C, the rod 616 and the compression coil spring 68 are examples of the “power transmitting part”. The piston cylinder 617 and the rod 616 are examples of the “reciprocating member”. The compression coil spring 68 is an example of the “elastic member”.

The battery mounting parts 4, 4J are examples of the “battery mounting part”. The intermediate shaft 60 and the oscillating member 613 are examples of the “intermediate shaft” and the “oscillating member”, respectively. The sleeve 22 is an example of the “sleeve”. The needle housing 90, the support 93 and the anvil 95 are examples of the “needle housing”, the “support” and the “anvil”, respectively. The bottom 931 and the peripheral wall 935 of the support 93 are examples of the “bottom” and the “peripheral wall” of the “support”, respectively. The large-diameter part 951 and the front small-diameter part 954 of the anvil 95 are examples of the “large-diameter part” and the “small-diameter part” of the “anvil”, respectively. The elastic element 98 is an example of the “elastic element”. The handle 3B and the grip part 31 are examples of the “handle” and the “grip part”, respectively. The trigger 35 is an example of the “operation member”. The lighting unit 39 is an example of the “lighting device”.

The needle scaler according to the present disclosure is not limited to the needle scalers 1A, 1B, 1C, 1D, 1E, 1F, 1G, 1H, 1I, 1J, 1K, 1L, 1M of the above-described embodiments. For example, the following non-limiting modifications may be made. At least one of these modifications can be adopted in combination with at least one of the features of the needle scalers 1A, 1B, 1C, 1D, 1E, 1F, 1G, 1H, 1I, 1J, 1K, 1L, 1M of the above-described embodiments and the claimed invention.

The structures of the power transmitting mechanism and the hammering mechanism are not limited to those of the hammering mechanisms of the above-described embodiments. For example, in other embodiments, the power transmitting mechanism and the hammering mechanism may use a crank shaft that is operably connected to the output shaft 515 of the motor 51, in place of the rotary body 611 and the oscillating member 613 on the intermediate shaft 60. In this case, a cylindrical piston may be slidably arranged within the cylinder 63 and operably connected to an eccentric pin provided on the crank shaft. It is advantageous that the rotary body 611 and the oscillating member 613 on the intermediate shaft 60 contribute to size reduction of the hammering mechanism 6.

Further, for example, in other embodiments, the power transmitting mechanism may be a cam type power transmitting mechanism that converts rotational driving power of the output shaft 515 or the intermediate shaft 60 to axial reciprocating motion. In this case, the power transmitting mechanism may have a driven member that reciprocates in the axial direction, and a cam member that rotates together with the output shaft 515 and the intermediate shaft 60 and converts rotary motion to reciprocating motion of the driven member, in place of the hammering mechanism 6, 6C, 6H, 6I. The driven member is an example of the “power transmitting part”.

The scaling mechanism of the needle scaler according to the present disclosure may just be configured to appropriately transmit the hammering force of the striker to the needles, and its structure is not limited to that of the scaling mechanism 9 of the above-described embodiments. For example, the needle housing 90 may be a single cylindrical member formed separately from the cylinder 63, instead of being formed by part of the cylinder 63 and the cylindrical member 900. The shapes of the support 93 and the anvil 95 may be appropriately changed, provided that the support 93 and the anvil 95 can slide within the needle housing 90. Further, for example, the support 93 and the anvil 95 need not be able to slide independently from each other within the needle housing 90, but may be fixed to each other and integrally slide. The biasing member 97 may be a mechanical spring other than a compression coil spring, or an elastic element (such as elastomer) other than a spring. The elastic element 98 may be changed to a mechanical spring (such as a compression coil spring).

In view of the nature of the present disclosure and the above-described embodiments, the following aspects are provided. At least one of the aspects can be adopted in combination with at least one of the features of the above-described embodiments and modifications and the claimed invention.

(Aspect A1) The scaling mechanism includes:

a needle housing that has a front end having an opening through which the needles are inserted;

a support that supports the needles to be movable in the respective axial directions within the needle housing; and

an anvil that is arranged between the striker and the support in the front-rear direction and can slide in the front-rear direction along the driving axis within the needle housing; and

the striker is configured to directly strike the anvil.

( Aspect A2) The support can slide in the front-rear direction along the driving axis within the needle housing.

(Aspect A3) The scaling mechanism includes a biasing member that is disposed between the support and the needle housing in the front-rear direction and biases the support and the anvil rearward relative to the needle housing.

(Aspect A4) The operation member is arranged away from the first and second ends of the grip part in the first direction.

(Aspect A5) The operation member is supported by the grip part so as to be linearly slidable.

(Aspect A6) The hammering mechanism further includes:

an intermediate shaft that is operably connected to the output shaft and rotates around a second rotational axis along with rotation of the output shaft; and

an oscillating member that is arranged on the intermediate shaft and oscillates in the front-rear direction along with rotation of the intermediate shaft;

the piston is operably connected to the oscillating member and linearly reciprocates along the driving axis along with oscillation of the oscillating member;

the driving axis, the first rotational axis and the second rotational axis are parallel to each other; and

the handle protrudes from the tool body in a direction toward the second rotational axis from the driving axis.

(Aspect A7) The needle scaler further comprises a battery mounting part to which a battery can be removably mounted; and

the driving axis passes through the battery mounting part when the needle scaler is viewed from a second direction orthogonal to the front-rear direction and the first direction.

(Aspect A8) The battery mounting part is provided in a rear end part of the tool body; and

the handle is arranged between the hammering mechanism and the battery mounting part in the front-rear direction.

( Aspect A9) At least part of the motor is arranged on the opposite side from the battery mounting part relative to the handle in the front-rear direction.

(Aspect A10) The needle scaler further includes a controller that controls driving of the needle scaler;

the controller is arranged between the motor and the battery mounting part in the front-rear direction; and

the driving axis passes through the motor , the controller and the battery mounting part.

(Aspect A11) A line orthogonal to the driving axis passes through the controller and the handle when the needle scaler is viewed from a second direction orthogonal to the front-rear direction and the first direction.

(Aspect A12) The battery mounting part includes an engagement part that is configured to be slidingly engaged with the battery in a direction crossing the driving axis.

(Aspect A13) The engagement part is configured to be slidingly engaged with the battery in the first direction.

The following aspects B1 to B10 are provided in order to solve a non-limiting object of the present disclosure to provide a technique that contributes to improvement of the durability of an electric needle scaler. The following aspects B1 to B10 can be adopted individually or in combination of at least two of them. Alternatively, at least one of the following aspects B1 to B10 can be adopted in combination with at least one of the needle scalers 1A, 1B, 1C, 1D, 1E, 1F, 1G, 1H, 1I, 1J, 1K, 1L, 1M of the above-described embodiments, the above-described modifications, the aspects A1 to A13 and the features of the claimed invention.

(Aspect B1) An electric needle scaler, comprising:

a tool body that extends along a driving axis that defines a front-rear direction of the needle scaler;

an electric motor that is housed in the tool body and includes an output shaft that is rotatable around a first rotational axis;

a hammering mechanism that is housed in the tool body; and

a scaling mechanism that is supported by a front end part of the tool body and includes needles that protrude forward to be exposed out of the tool body and are supported to be movable in respective axial directions of the needles;

wherein the hammering mechanism includes: (i) a piston that is operably connected to the output shaft of the motor and reciprocates along the driving axis along with rotation of the output shaft; and (ii) a striker that reciprocates along the driving axis by pressure fluctuations caused in an air chamber by reciprocation of the piston and applies hammering force to the needles.

The needle scaler according to aspect B1has the hammering mechanism that is driven by power of the electric motor. The hammering mechanism reciprocates the striker by the action of air spring, or specifically by pressure fluctuations caused in the air chamber by reciprocation of the piston, and applies hammering force to the needles of the scaling mechanism. Therefore, the needle scaler is provided with excellent durability, compared with a structure in which the piston and the striker are connected by a mechanical spring (such as a compression coil spring) in order to apply the hammering force.

(Aspect B2) The needle scaler as defined in aspect B1 may further comprise a battery mounting part that is configured to removably receive a battery.

According to this aspect, the needle scaler is provided with excellent operability and portability, compared with a needle scaler that can be connected to an external commercial power source. The battery mounting part typically includes an engagement part (such as a guide rail and a guide groove) that can be physically engaged with the battery, and a connector part having terminals that can be electrically connected to the battery.

(Aspect B3) The needle scaler as defined in aspect B1 or B2, wherein the hammering mechanism may include an intermediate shaft and an oscillating member. The intermediate shaft may be operably connected to the output shaft and configured to rotate around a second rotational axis parallel to the first rotational axis along with rotation of the output shaft. The oscillating member may be arranged on the intermediate shaft and configured to oscillate in the front-rear direction along with rotation of the intermediate shaft. The piston may be operably connected to the oscillating member and configured to linearly reciprocate along the driving axis along with oscillation of the oscillating member.

According to this aspect, the motion converting mechanism that converts rotary motion of the output shaft of the motor into linear motion of the piston is reduced in size, compared with a structure using a crank-piston mechanism.

(Aspect B4) The needle scaler as defined in aspect B3, wherein the piston may comprise a bottomed cylindrical piston cylinder. The striker may be slidable along the driving axis within the piston cylinder. The air chamber may be defined between a bottom of the piston cylinder and the striker.

According to this aspect, the hammering mechanism is reduced in size, compared with a structure in which a cylindrical piston is arranged within a cylinder formed separately from the piston.

(Aspect B5) The needle scaler as defined in any one of aspects B1 to B4 may further comprise a sleeve that is arranged within the front end part of the tool body and holds the scaling mechanism. The front end part of the tool body may be made of synthetic resin. The sleeve may be made of metal and integrally formed with the front end part of the tool body. The scaling mechanism having the needles that move in the axial direction is easy to generate heat.

According to this aspect, the tool body having the holding part (sleeve) that holds the scaling mechanism is provided with excellent durability, and the number of parts in assembling is reduced.

(Aspect B6) The needle scaler as defined in any one of aspects B1 to B5, wherein the scaling mechanism may include a needle housing, a support and an anvil. The needle housing may have a front end having an opening through which the needles are inserted, and may be fixed to the tool body. The support may support the needles to be movable in the respective axial directions. The anvil may be arranged between the striker and the support in the front-rear direction. The anvil may be configured to apply hammering force to the needles by being struck by the striker. The support may have a bottomed cylindrical shape and include a bottom and a cylindrical peripheral wall. The bottom may have holes through which the needles are respectively inserted. The peripheral wall may extend rearward from an outer peripheral edge of the bottom and may be configured to slide in the front-rear direction along the driving axis within the needle housing. The anvil may include a large-diameter part and a small-diameter part. The large-diameter part may be configured to slide in the front-rear direction along the driving axis within the needle housing. The small-diameter part may protrude forward from the large-diameter part and have a smaller outer diameter than the large-diameter part. A rear end part of the peripheral wall of the support is configured to be fitted onto the small-diameter part of the anvil.

According to this aspect, the anvil and the support substantially integrally slide within the needle housing, so that the anvil is restrained from tilting relative to the needle housing while the whole length of the anvil in the axial direction is reduced.

(Aspect B7) The needle scaler as defined in aspect B6, wherein one end part of each of the needles in the axial direction can move within a space that is defined between the bottom of the support and the anvil in the front-rear direction and surrounded by the peripheral wall of the support.

According to this aspect, the space in which the needles can move in the axial direction is appropriately secured by the support and the anvil.

(Aspect B8) The needle scaler as defined in any one of aspects B1 to B7, wherein the scaling mechanism may include a needle housing, a support, an anvil and an elastic element. The needle housing may have a front end having an opening through which the needles are inserted, and may be fixed to the tool body. The support may support the needles to be movable in the respective axial directions. The support may be configured to slide in the front-rear direction along the driving axis within the needle housing. The anvil may be arranged between the striker and the support in the front-rear direction and configured to slide in the front-rear direction along the driving axis within the needle housing. The anvil may be configured to apply hammering force to the needles by being struck by the striker. The elastic element may be disposed between the anvil and a rear end part of the needle housing in the front-rear direction.

According to this aspect, the elastic element alleviates impact of collision when the needles are bounced back rearward by reaction and collide with the anvil.

(Aspect B9) The needle scaler as defined in any one of aspects B1 to B8 may further comprise a handle and an operation member. The handle may be connected to the tool body and include a grip part extending in a first direction crossing the driving axis. The operation member may be provided on a front side of the grip part and configured to be manually operated by a user to instruct start of the motor. The grip part may have a first end that is closer to the tool body and a second end that is farther from the tool body, in the first direction. The operation member may be arranged in a region of the grip part that includes at least a center position of the grip part that is substantially equidistant from the first and second ends in the first direction.

According to this aspect, the operation member is arranged in a region including a center position in the first direction (or the longitudinal direction of the grip part). Thus, the operation member can be easily operated with one or more fingers of a user, whether the user holds the grip part in an orientation with a thumb on a first end side (on the end of the tool body side) of the grip part, or in an orientation with the thumb on a second end side (opposite side from the tool body) of the grip part. Further, the needle scaler can be used in various attitudes, but the orientation in which the grip part is held does not substantially affect the operability of the operation member, so that the needle scaler exhibits superior operability in various attitudes.

(Aspect B10) The needle scaler as defined in any one of aspects B1 to B9 may further comprise a lighting device that is arranged to illuminate an area forward of the needles.

According to this aspect, workability in a dark place is improved.

Correspondences between the features of aspects B1 to B10 and the features of the present disclosure or invention are as follows. However, the features of the above-described embodiments are merely exemplary and do not limit the features of aspects B1 to B10.

The needle scalers 1A, 1B are examples of the “needle scaler”. The tool body 2A, 2B are examples of the “tool body”. The motor 51 is an example of the “motor”. The hammering mechanism 6 is an example of the “hammering mechanism”. The scaling mechanism 9 and the needle 91 are examples of the “scaling mechanism” and the “needles”, respectively. The piston cylinder 617 and the striker 65 are examples of the “piston” and the “striker”, respectively.

The battery mounting part 4 is an example of the “battery mounting part”. The intermediate shaft 60 and the oscillating member 613 are examples of the “intermediate shaft” and the “oscillating member”, respectively. The sleeve 22 is an example of the “sleeve”. The needle housing 90, the support 93 and the anvil 95 are examples of the “needle housing”, the “support” and the “anvil”, respectively. The bottom 931 and the peripheral wall 935 of the support 93 are examples of the “bottom” and the “peripheral wall” of the “support”, respectively. The large-diameter part 951 and the front small-diameter part 954 of the anvil 95 are examples of the “large-diameter part” and the “small-diameter part” of the “anvil”, respectively. The elastic element 98 is an example of the “elastic element”. The handle 3B and the grip part 31 are examples of the “handle” and the “grip part”, respectively. The trigger 35 is an example of the “operation member”. The lighting unit 39 is an example of the “lighting device”.

### DESCRIPTION OF THE REFERENCE NUMERALS

1A, 1B, 1C, 1D, 1E, 1F, 1G, 1H, 1I, 1J, 1K, 1L, 1M: needle scaler, 2A, 2B, 2D, 2H: tool body, 201: projection, 21: barrel part, 22: sleeve, 221: flange, 227: elastic element, 24: support, 241: cylindrical part, 25: rear end part, 25R: rear end, 251: rear wall part, 253: side wall part, 27: body extending part, 3A, 3B, 3D, 3F, 3H, 3J, 3L: handle, 31: grip part, 31F: front end, 31R: rear end, 311: front wall part, 312: opening, 32A, 32B, 32F, 32H, 32J: lower end part, 320: battery insertion part, 321: opening, 322: guide wall, 340: upper extending part, 342: front extending part, 344: lower extending part, 35: trigger, 37: touch switch, 38: switch, 381: switch body, 383: plunger, 39: lighting unit, 4, 4J: battery mounting part, 41, 41J: engagement part, 42: guide groove, 45, 45J: connector part, 47: recessed part, 40: battery, 400: mounting surface, 401: surface, 403: guide rail, 405: connector part, 407, 407J: locking member, 408: release button, 50: controller, 51: motor, 511: stator, 513: rotor, 515: output shaft, 516: pinion, 517: bearing, 518: bearing, 6, 6C, 6H, 6I: hammering mechanism, 60: intermediate shaft, 601: bearing, 602: bearing, 605, 605H: gear, 61, 61H: motion converting mechanism, 611: rotary body, 612: spring receiver, 613: oscillating member, 614: ring part, 615: arm part, 616: rod, 617: piston cylinder, 618: washer, 619: bolt, 63: cylinder, 631: large-diameter part, 633: shoulder part, 635: small-diameter part, 636: small flange, 637: recess, 638: large flange, 64: rotation stopper ring, 641: recess, 643: projection, 644: groove, 645: ball, 65, 65C: striker, 651: recess, 652:bottom, 653: recess, 654: through hole, 66: air chamber, 68: compression coil spring, 9: scaling mechanism, 90: needle housing, 900: cylindrical member, 901: wall, 902: opening, 904: flange, 91: needle, 911: body, 915: head, 93: support, 931: bottom, 932: hole, 935: peripheral wall, 95: anvil, 951: large-diameter part, 954: front small-diameter part, 956: rear small-diameter part, 957: rear projection, 96: space, 97: biasing member, 98: elastic element, CL: center position, DX: driving axis, RX1: rotational axis, RX2: rotational axis, S: working surface

1. An electric needle scaler, comprising:
a tool body, at least part of which extends along a driving axis that defines a front-rear direction of the needle scaler;
an electric motor that is housed in the tool body and includes an output shaft that is rotatable around a first rotational axis;
a battery mounting part that is configured to removably receive a battery;
a power transmitting mechanism that is housed in the tool body; and
a scaling mechanism that is supported by a front end part of the tool body and includes needles that protrude forward to be exposed out of the tool body and are supported to be movable in respective axial directions of the needles;
wherein:
the power transmitting mechanism includes a power transmitting part that is operably connected to the output shaft of the motor and reciprocates along the driving axis by utilizing rotation of the output shaft and transmit force to the needles in the respective axial directions.

2. The needle scaler as defined in claim 1, wherein the power transmitting mechanism includes: (i) a reciprocating member that is operably connected to the output shaft of the motor and reciprocates along the driving axis along with rotation of the output shaft; and (ii) a striker as the power transmitting part that applies hammering force to the needles by reciprocation of the reciprocating member.

3. The needle scaler as defined in claim 2, wherein:
the power transmitting mechanism includes: (i) an intermediate shaft that is operably connected to the output shaft and rotates around a second rotational axis parallel to the first rotational axis along with rotation of the output shaft; and (ii) an oscillating member that is arranged on the intermediate shaft and oscillates in the front-rear direction along with rotation of the intermediate shaft; and
the reciprocating member is operably connected to the oscillating member and linearly reciprocates along the driving axis along with oscillation of the oscillating member.

4. The needle scaler as defined in claim 3, further comprising:
a handle that is connected to the tool body and includes a grip part extending in a first direction crossing the driving axis;
wherein:
the driving axis, the first rotational axis and the second rotational axis are parallel to each other; and
the handle protrudes from the tool body in a direction toward the second rotational axis from the driving axis.

5. The needle scaler as defined in claim 2, wherein:
the reciprocating member comprises a piston that forms an air chamber between the reciprocating member and the striker; and
the striker reciprocates along the driving axis by pressure fluctuations caused in the air chamber by reciprocation of the piston.

6. The needle scaler as defined in claim 5, wherein:
the piston comprises a bottomed cylindrical piston cylinder;
the striker is slidable along the driving axis within the piston cylinder; and
the air chamber is defined between a bottom of the piston cylinder and the striker.

7. The needle scaler as defined in claim 2, wherein:
the power transmitting mechanism further includes an elastic member that elastically connects the reciprocating member and the striker; and
the striker reciprocates along the driving axis by an elastic force of the elastic member that is generated by reciprocation of the reciprocating member.

8. The needle scaler as defined in claim 1, further comprising:
a sleeve that is arranged within the front end part of the tool body and holds the scaling mechanism,
wherein:
the front end part of the tool body is made of synthetic resin; and
the sleeve is made of metal and integrally formed with the front end part.

9. The needle scaler as defined in claim 1, wherein;
the scaling mechanism includes:
a needle housing that has a front end having an opening through which the needles are inserted, and is fixed to the tool body;
a support that supports the needles to be movable in the respective axial directions; and
an anvil that is arranged between the power transmitting part and the support in the front-rear direction, and configured to apply the axial force to the needles by being struck by the power transmitting part;
wherein:
the support has a bottomed cylindrical shape, and includes: (i) a bottom having holes through which the needles are respectively inserted; and (ii) a peripheral wall that has cylindrical shape and extends rearward from an outer peripheral edge of the bottom and is configured to slide in the front-rear direction along the driving axis within the needle housing;
the anvil includes: (i) a large-diameter part that is configured to slide in the front-rear direction along the driving axis within the needle housing; and (ii) a small-diameter part that protrudes forward from the large-diameter part and has a smaller outer diameter than the large-diameter part; and
a rear end part of the peripheral wall of the support is configured to be fitted onto the small-diameter part of the anvil.

10. The needle scaler as defined in claim 9, wherein one end part of each of the needles in the axial direction is movable within a space that is defined between the bottom of the support and the anvil in the front-rear direction and surrounded by the peripheral wall of the support.

11. The needle scaler as defined in claim 10, wherein:
the support is configured to slide in the front-rear direction along the driving axis within the needle housing;
the anvil is configured to slide in the front-rear direction along the driving axis within the needle housing; and
the needle scaler includes an elastic element that is disposed between the anvil and a rear end part of the needle housing in the front-rear direction.

12. The needle scaler as defined in claim 1, wherein:
the scaling mechanism includes:
a needle housing that has a front end having an opening through which the needles are inserted, and is fixed to the tool body;
a support that supports the needles to be movable in the respective axial directions and is configured to slide in the front-rear direction along the driving axis within the needle housing; and
an anvil that is arranged between the power transmitting part and the support in the front-rear direction and is configured to slide in the front-rear direction along the driving axis within the needle housing, the anvil being configured to apply the axial force to the needles by being struck by the power transmitting part; and
the needle scaler includes an elastic element that is disposed between the anvil and a rear end part of the needle housing in the front-rear direction.

13. The needle scaler as defined in claim 1, further comprising:
a handle that is connected to the tool body and includes a grip part extending in a first direction crossing the driving axis; and
an operation member that is provided on a front side of the grip part and configured to be manually operated by a user to instruct start of the motor;
wherein:
the grip part has a first end that is closer to the tool body and a second end that is farther from the tool body, in the first direction; and
the operation member is arranged in a region of the grip part that includes at least a center position of the grip part that is substantially equidistant from the first and second ends in the first direction.

14. The needle scaler as defined in claim 1, further comprising a lighting device that is arranged to illuminate an area forward of the needles.

15. The needle scaler as defined in claim 1, further comprising:
a handle that is connected to the tool body and includes a grip part extending in a first direction crossing the driving axis;
wherein a line orthogonal to the driving axis passes through the battery mounting part and the handle when the needle scaler is viewed from a second direction orthogonal to the front-rear direction and the first direction.

16. An electric needle scaler, comprising:
a tool body, at least part of which extends along a driving axis that defines a front-rear direction of the needle scaler;
an electric motor that is housed in the tool body and includes an output shaft that is rotatable around a first rotational axis;
a hammering mechanism that is housed in the tool body; and
a scaling mechanism that is supported by a front end part of the tool body and includes needles that protrude forward to be exposed out of the tool body and are supported to be movable in respective axial directions of the needles;
wherein the hammering mechanism includes: (i) a piston that is operably connected to the output shaft of the motor and reciprocates along the driving axis along with rotation of the output shaft; and (ii) a striker that reciprocates along the driving axis by pressure fluctuations caused in an air chamber by reciprocation of the piston and applies hammering force to the needles.
